(19) United States
(12) Patent Application Publication
(10) Pub. No.: US 2019/0301855 A1
(43) Pub. Date: Oct. 3, 2019

(54) PARALLAX DETECTION DEVICE, DISTANCE DETECTION DEVICE, ROBOT DEVICE, PARALLAX DETECTION METHOD, AND DISTANCE DETECTION METHOD

(71) Applicant: CANON KABUSHIKI KAISHA, Tokyo (JP)

(72) Inventor: Kiyokatsu Ikemoto, Yokohama-shi (JP)

(21) Appl. No.: 16/364,987

(22) Filed: Mar. 26, 2019

(30) Foreign Application Priority Data
Mar. 30, 2018 (JP) 2018-067499
Nov. 8, 2018 (JP) 2018-210864

(51) Int. Cl. G01B 11/14; G01B 11/25; G06F 17/15

(52) U.S. Cl. CPC G01B 11/14; G06F 17/15; G01B 11/254; G01B 11/2513

(57) ABSTRACT

A parallax detection device is provided. The device obtains an image pair having parallax; sets a base image in one of images in the image pair; calculates the first and second correlation values of the image pair; and calculates a parallax amount of the image pair using the correlation values. The device calculates the first and second correlation values respectively based on the first and second based images set in one of the images in the image pair, wherein the second base image is set at a position different from the position of the first base image with respect to a prescribed direction.

### BACKGROUND OF THE INVENTION

### Field of the Invention

The aspect of the embodiments relates to a parallax detection device, a distance detection device, a robot device, a parallax detection method, and a distance detection method.

### Description of the Related Art

Methods of obtaining a captured image of an object and calculating distance information with respect to the object from the captured image have been proposed. One example of such a method involves obtaining an image pair including images from different viewpoints, finding a parallax amount from a correlation value (also called a “degree of similarity”) between the two images, and obtaining distance information.

Specifically, an image signal in a partial region containing a pixel of interest is first extracted, as a base image, from one of the images in the image pair. Next, an image signal in a partial region of the other image is extracted as a referred image. Correlation values are then calculated (correlation calculation) between the base image and each of positions in the referred image, while varying the positions in the image where the referred image is extracted. Finding the position where the calculated correlation value between the base image and the referred image at each of the stated positions is the highest makes it possible to calculate the parallax amount at the pixel of interest. Then, converting the parallax amount into distance information through a known method makes it possible to calculate distance information of the object.

However, if a region having a weak pattern is present in the captured image, the contrast of the image signal will drop, which can lead to cases where the parallax amount cannot be calculated through correlation calculation and the distance information therefore cannot be calculated (the distance cannot be measured). In response to this, Japanese Patent No. 5803065 proposes a method that makes it possible to measure distances for such regions by obtaining a captured image while projecting patterned light.

However, when measuring distance using an image captured while projecting patterned light, calculating the parallax amount in a state where a region where the pixel values in the captured image vary drastically (boundary parts between bright regions and dark regions of the projected pattern) overlaps with an end part of the base image will result in error arising in the calculated parallax amount. In this case, the error that has arisen in the parallax amount will also result in error arising in the distance information found by converting the parallax amount. This error is particularly marked when measuring the distance by projecting patterned light having periodicity, such as a line pattern in which high-brightness regions and low-brightness regions are arranged in an alternating manner. Such calculation error in the parallax amount can arise in a similar manner when finding the parallax amount using a captured image of an object that has a pattern with periodicity.

### SUMMARY OF THE INVENTION

Accordingly, the aspect of the embodiments provides a parallax detection device comprising: at least one processor; and a memory coupled to the at least one processor, the memory having instructions that, when executed by the at least one processor, performs operations as: an obtainment unit configured to obtain an image pair having parallax; a correlation calculation unit configured to set a base image in one of images in the image pair and calculate a correlation value of the image pair based on the base image; and a parallax calculation unit configured to calculate a parallax amount of the image pair using the correlation value. The correlation calculation unit sets a first base image in one of the images in the image pair, and calculates a first correlation value based on the first base image. The correlation calculation unit sets a second base image in the one of the images in the image pair, at a position different from the position of the first base image with respect to a prescribed direction. The correlation calculation unit calculates a second correlation value based on the second base image. The parallax calculation unit calculates the parallax amount using the first correlation value and the second correlation value.

Further features of the disclosure will become apparent from the following description of exemplary embodiments with reference to the attached drawings.

### BRIEF DESCRIPTION OF THE DRAWINGS

FIGS. 1A and 1B illustrate examples of the overall configuration of a distance detection device according to a first embodiment.

FIGS. 2A and 2B illustrate examples of the overall configuration of a pixel included in an image sensor according to a first embodiment.

FIGS. 3A to 3C are diagrams illustrating a distance detection method according to the first embodiment.

FIGS. 4A and 4B illustrate examples of a measurement result according to the first embodiment.

FIGS. 5A to 5E are diagrams illustrating a distance detection method according to the first embodiment.

FIG. 6 is a diagram illustrating a distance detection method according to the first embodiment.

FIGS. 7A and 7B are diagrams illustrating a distance detection method according to a variation on the first embodiment.

FIG. 8 illustrates the flow of a distance detection method according to a variation on the first embodiment.

FIG. 9 illustrates an example of the overall configuration of a robot device according to a second embodiment.

FIG. 10A illustrates an example of the overall configuration of a distance detection device according to a third embodiment.

FIG. 10B illustrates the flow of a distance detection method according to the third embodiment.

FIGS. 11A and 11B illustrate examples of patterned light according to a fourth embodiment.

FIGS. 12A to 12C are diagrams illustrating a distance detection method according to the fourth embodiment.

FIG. 13 illustrates an example of a measurement result according to the fourth embodiment.

FIGS. 14A to 14F are diagrams illustrating a distance detection method according to the fourth embodiment.

FIGS. 15A and 15B are diagrams illustrating a distance detection method according to the fourth embodiment.

FIGS. 16A to 16D illustrate examples of the overall configuration of a distance detection device according to a fifth embodiment.

FIGS. 17A to 17C are diagrams illustrating a distance detection method according to the fifth embodiment.

FIG. 18 illustrates an example of the overall configuration of a distance detection device according to a sixth embodiment.

FIGS. 19A to 19C are diagrams illustrating a distance detection method according to the sixth embodiment.

FIG. 20 illustrates an example of a measurement result according to the sixth embodiment.

FIGS. 21A to 21F are diagrams illustrating a distance detection method according to the sixth embodiment.

FIGS. 22A and 22B are diagrams illustrating a distance detection method according to the sixth embodiment.

FIG. 23 is a diagram illustrating a distance detection method according to a variation on the sixth embodiment.

### DESCRIPTION OF THE EMBODIMENTS

Exemplary embodiments of the disclosure will now be described in detail in accordance with the accompanying drawings. Note, however, that the dimensions, materials, shapes, relative positions of constituent elements, and the like described in the following embodiments are merely examples, and can be changed in accordance with the configuration of the device to which the disclosure is applied, or various other conditions. Furthermore, like reference signs are used throughout the drawings to indicate elements that are the same or functionally similar.

### First Embodiment

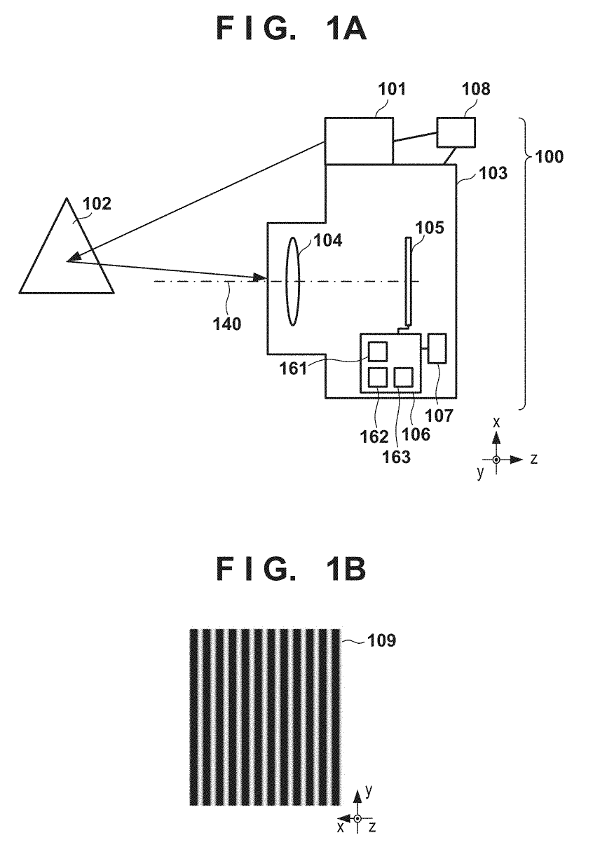

A distance detection device according to a first embodiment of the disclosure will be described hereinafter with reference to FIGS. 1A through 6. FIGS. 1A and 1B illustrate examples of the overall configuration of a distance detection device according to the present embodiment. FIG. 1A illustrates an example of the overall configuration of a distance detection device 100 that employs the projection of patterned light. FIG. 1B illustrates an example of projected patterned light.

Device Configuration

The distance detection device 100 according to the present embodiment is provided with a projection device 101 and an image capturing device 103. The projection device 101 projects patterned light onto an object 102, and the image capturing device 103 obtains a captured image by capturing an image of the object 102 using returning light of the patterned light which returns from the object 102. The projection device 101 and the image capturing device 103 are connected to a control unit 108, and the control unit 108 controls the synchronization and the like between the projection device 101 and the image capturing device 103. Note that the projection device 101 can be fixed to the image capturing device 103 using any desired method, and may be fixed to the image capturing device 103 in a removable manner.

The projection device 101 is provided with a light source and an image forming optical system, as well as a pattern mask in which a pattern is formed in frosted glass, a metal sheet, or the like, as an example of pattern forming means (these elements are not shown). A light-emitting diode (LED) or the like can be used as the light source. Note that providing only these constituent elements in the projection device 101 makes it possible to reduce the cost and size of the device. Additionally, in the present embodiment, a line pattern 109, illustrated in FIG. 1B, is an example of the patterned light projected by the projection device 101.

The image capturing device 103 is provided with an image forming optical system 104, an image sensor 105, a calculation processing unit 106, and main memory 107. Note that the image capturing device 103 may be provided with a mount or the like for securing the projection device 101.

The image forming optical system 104 has a function for forming an image of the object 102 on the image sensor 105, which is an image capturing surface. The image forming optical system 104 is provided with a plurality of lens groups, an aperture stop, and so on (not shown). The image forming optical system 104 has an exit pupil located a prescribed distance from the image sensor 105. Here, in FIG. 1A, an optical axis 140 of the image forming optical system 104 is indicated by a single dot-dash line, and the optical axis 140 is parallel to a z-axis. An x-axis and a y-axis are perpendicular to each other, and are axes perpendicular to the optical axis 140 and the z-axis.

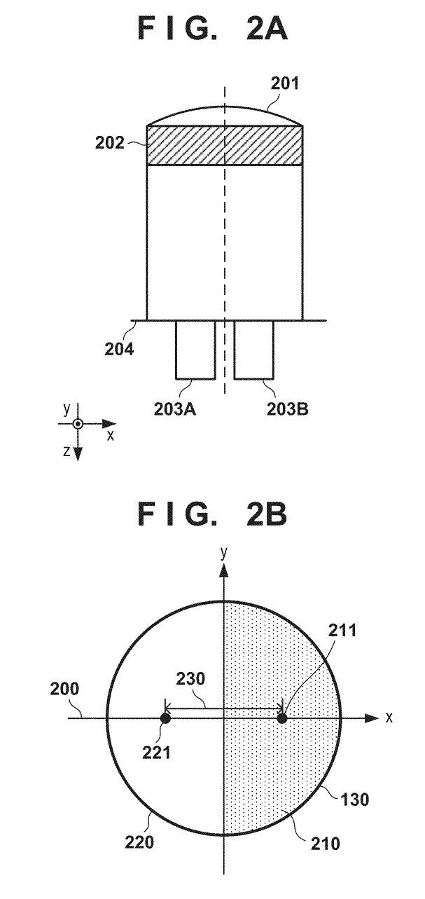

A substrate 204 and a plurality of pixels are arranged in the image sensor 105. Here, FIGS. 2A and 2B illustrate an example of the overall configuration of the pixels in the image sensor 105. FIG. 2A is a cross-sectional view of a pixel arranged in the image sensor 105.

Each pixel is provided with a microlens 201, a color filter 202, and photoelectric conversion units 203A and 203B. In the image sensor 105, red, green, and blue (RGB) spectral properties are provided for each pixel by the color filter 202 according to the wavelength band to be detected. The pixels are arranged on an xy plane so as to form a known color arrangement pattern (not shown). The photoelectric conversion units 203A and 203B, which are sensitive to the wavelength bands to be detected, are formed on a pixel-by-pixel basis on the substrate 204 of the image sensor 105. Each pixel is provided with wiring (not shown), and the pixels can send output signals (image signals) to the calculation processing unit 106 over that wiring.

FIG. 2B illustrates an exit pupil 130 of the image forming optical system 104, seen from a point of intersection between the optical axis 140 and the image sensor 105 (central image height). A first light beam passing through a first pupil region 210, and a second light beam passing through a second pupil region 220, are incident on the photoelectric conversion unit 203A and the photoelectric conversion unit 203B, respectively. The stated pupil regions are different regions of the exit pupil 130. By photoelectrically converting the light beams incident on the photoelectric conversion unit 203A and the photoelectric conversion unit 203B in each pixel, image signals corresponding to an A image and a B image, respectively, can be generated. The generated image signals are sent to the calculation processing unit 106, which is an example of calculation means, and the calculation processing unit 106 generates the A image and B image on the basis of the received image signals. The calculation processing unit 106 calculates a distance value by performing a distance detection process using the A image and the B image, and stores the calculated distance value in the main memory 107. Additionally, the calculation processing unit 106 can store an image obtained by adding the A image and the B image in the main memory 107 as image information, and can use that information in subsequent processing. Note that the calculation processing unit 106 can also store the A image and the B image themselves in the main memory 107.

FIG. 2B also illustrates a center position of the first pupil region 210 (a first center position 211) and a center position of the second pupil region 220 (a second center position 221). In the present embodiment, the first center position 211 is shifted (moved) from the center of the exit pupil 130 along a first axis 200. On the other hand, the second center position 221 is shifted (moved) in the direction opposite from the first center position 211, along the first axis 200. A direction connecting the first center position 211 and the second center position 221 is called a “pupil division direction”. Additionally, a distance between the centers of the first center position 211 and the second center position 221 corresponds to a baseline length 230.

The positions of the A image and the B image are shifted in the same direction as the pupil division direction (the x-axis direction, in the present embodiment) due to defocus. The amount of relative positional shift between the images, i.e., the parallax amount between the A image and the B image, is an amount based on the defocus amount. As such, the parallax amount can be obtained through the method described later and then converted into a defocus amount through a known conversion method. The defocus amount can be converted into distance information through a known conversion method.

The calculation processing unit 106 is provided with a correlation calculation unit 161, a parallax calculation unit 162, and a distance calculation unit 163. The correlation calculation unit 161 sets an image of a partial region including a pixel subject to distance calculation (a pixel of interest) in the A image as a base image, sets the B image to a referred image, and calculates a correlation value between the base image and the referred image while moving the position of the referred image in a prescribed direction.

The parallax calculation unit 162 calculates a parallax amount in an image pair including the A image and the B image, using the correlation value calculated by the correlation calculation unit 161. The distance calculation unit 163 calculates the distance to the object 102 using the parallax amount calculated by the parallax calculation unit 162.

Note that the control unit 108 may be configured using a generic computer, or may be configured as a dedicated computer for the distance detection device 100. The constituent elements of the calculation processing unit 106 can be constituted by software modules executed by a calculation device such as a central processing unit (CPU) or a micro processing unit (MPU). Likewise, the constituent elements of the calculation processing unit 106 may be constituted by circuits or the like that realize specific functions, such as ASICs. Furthermore, the control unit 108, which carries out synchronization control and so on between the projection device 101 and the image capturing device 103, may be realized by the calculation processing unit 106 of the image capturing device 103. The main memory 107 may be constituted by any known memory such as RAM, ROM, or the like.

Flow of Distance Detection Process

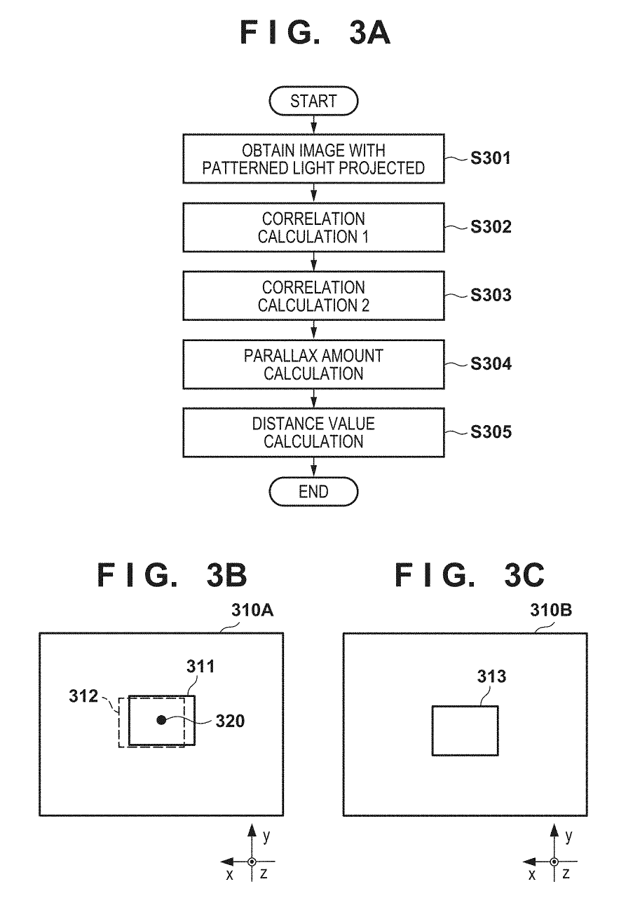

The flow of the distance detection process according to the present embodiment will be described next with reference to FIGS. 3A to 3C. FIG. 3A is a flowchart illustrating the distance detection process according to the present embodiment, and FIGS. 3B and 3C are diagrams illustrating the correlation calculation carried out by the correlation calculation unit 161. When the distance detection process according to the present embodiment is started, the process moves to S301.

In S301, “obtain image with patterned light projected”, an image is captured by the image capturing device 103 in a state where the patterned light is projected onto the object 102 by the projection device 101, and the captured image is stored in the main memory 107. Specifically, first, light having the line pattern 109 is generated by a spatial light modulator (not shown), which serves as an example of pattern control means provided within the projection device 101, and the light is then emitted onto the surface of the object 102. In this state, the image capturing device 103 captures an image, generates and obtains an image pair including the A image and the B image, which have parallax, and stores the obtained image pair in the main memory 107. At this time, the control unit 108 controls the operations and timings of the projection device 101 and the image capturing device 103 so that the image capturing device 103 carries out exposure in a state where the patterned light is projected.

Here, if an image of an object 102 having a weak pattern (also called a “texture”) is captured using only the surrounding ambient light, the contrast, S/N ratio, and the like will drop in the A image and the B image, which causes a drop in the accuracy of the distance calculation (distance measurement calculation) carried out through correlation calculation. However, emitting/projecting the patterned light onto the object 102 from the projection device 101 and capturing an image in a state where a texture is superimposed on the surface of the object 102 makes it possible to improve the accuracy of the distance calculation.

The processing from S302 to S305 is carried out by the calculation processing unit 106. Here, FIGS. 3B and 3C are diagrams illustrating the positional relationship between the base image and the referred image set in S302 and S303. FIG. 3B illustrates an A image 310A, and FIG. 3C indicates a B image 310B.

In S302, “correlation calculation 1”, the correlation calculation unit 161 of the calculation processing unit 106 calculates a first correlation value for the A image 310A and the B image 310B. Specifically, first, the correlation calculation unit 161 extracts a partial region of the A image 310A, containing a pixel of interest 320 and the pixels in the periphery thereof, and sets that partial region as a first base image 311. Next, the correlation calculation unit 161 extracts a region, in the B image 310B, having the same area (image size) as the first base image 311, and sets that region as a referred image 313. The correlation calculation unit 161 then moves the position in the B image 310B from where the referred image 313 is extracted in the same x-axis direction as the pupil division direction, and calculates a correlation value between the referred image 313 and the first base image 311 every given amount of movement (at each position). In this manner, the correlation calculation unit 161 calculates the first correlation value from a data string of correlation values corresponding to each amount of movement. Note that the correlation calculation unit 161 can set the referred image 313 as an image having the same vertical and horizontal dimensions as the first base image 311.

The direction in which the correlation calculation is carried out while moving the referred image 313 will be called a “parallax calculation direction”. Setting the parallax calculation direction to be the same direction as the pupil division direction makes it possible to correctly calculate a parallax amount produced by the distance to the object in the A image 310A and the B image 310B. Typical calculation methods, such as Sum of Absolute Difference (SAD) or Sum of Squared Difference (SSD), can be used for the method of calculating the correlation value.

Next, in S303, “correlation calculation 2”, the correlation calculation unit 161 calculates a second correlation value of the A image 310A and the B image 310B. Specifically, the correlation calculation unit 161 extracts a partial region, in the A image 310A, which has the same area (image size) as the first base image 311 and which is in a different position with respect to the pupil division direction (the x-axis direction), and sets that partial region as a second base image 312. Next, the correlation calculation unit 161 extracts a region, in the B image 310B, having the same area (image size) as the second base image 312, and sets that region as the referred image 313. After this, the correlation calculation unit 161 moves the position of the referred image 313 in the parallax calculation direction and calculates a correlation value between the referred image 313 and the second base image 312 every amount of movement, in the same manner as in S302. In this manner, the correlation calculation unit 161 calculates the second correlation value from a data string of correlation values corresponding to each amount of movement. Note that the correlation calculation unit 161 can set the second base image 312 as an image having the same vertical and horizontal dimensions as the first base image 311.

In correlation calculation 2, the referred image 313 corresponding to the second base image 312 can be set under the same conditions as the setting conditions for the referred image 313 corresponding to the first base image 311. For example, the referred image 313 can be set to be an image in the position in the B image 310B that corresponds to the position of the first base image 311 in the A image 310A. In this case, in correlation calculation 2, the referred image 313 may be set to be an image in the position in the B image 310B that corresponds to the position of the second base image 312 in the A image 310A. Note that the correspondence relationship between the position in the A image 310A and the position in the B image 310B may be specified through a known method. For example, the correspondence relationship can be specified on the basis of the structure of the pixels from which the image signals constituting the respective images are obtained.

Additionally, in correlation calculation 2, the amount of movement in the referred image 313 can be substantially the same as the amount of movement in the referred image 313 in correlation calculation 1. For example, if the amount of movement of the referred image 313 in correlation calculation 1 is from −M to +M, the correlation calculation unit 161 can set the amount of movement of the referred image 313 to from −M to +M in correlation calculation 2 as well.

In S304, “parallax amount calculation”, the parallax calculation unit 162 of the calculation processing unit 106 calculates the parallax amount using the first correlation value and the second correlation value found in S302 and S303. Specifically, the parallax calculation unit 162 calculates a third correlation value by adding, or finding the arithmetic mean of, the first correlation value and the second correlation value from every amount of movement. At this time, the parallax calculation unit 162 can calculate the third correlation value from a data string of the correlation values found by adding, or finding the arithmetic mean of, the first correlation value and the correlation value, among the second correlation values, from the corresponding amount of movement. For example, the parallax calculation unit 162 can add or find the arithmetic mean of the first correlation value and the second correlation value at the amount of movement −M of the referred image to calculate the third correlation value corresponding to the amount of movement −M.

Then, the parallax calculation unit 162 calculates the parallax amount using the third correlation value through a desired known method. For example, the parallax amount can be calculated by extracting a data string containing the amount of movement where the highest of the third correlation values is obtained and correlation values corresponding to similar amounts of movement, and then estimating, with sub pixel accuracy, the amount of movement at which the correlation is the highest through a desired known interpolation method.

In S305, “distance value calculation”, the distance calculation unit 163 of the calculation processing unit 106 converts the parallax amount into a defocus amount or an object distance using a desired known method. The conversion from the parallax amount to the defocus amount can be carried out using a geometric relationship employing a baseline length. The conversion from the defocus amount to the object distance can be carried out using an image forming relationship of the image forming optical system 104. The parallax amount may be converted to a defocus amount or an object distance by multiplying the parallax amount by a prescribed conversion coefficient. Using such a method makes it possible for the distance calculation unit 163 to calculate the distance to the object 102 using the parallax amount at the pixel of interest 320.

In this manner, with the distance detection method according to the present embodiment, the first base image 311 and the second base image 312 are set at different positions in the pupil division direction (the parallax calculation direction), correlation values are calculated for the referred image 313 set for each of the base images, and the parallax amount is calculated on the basis of the correlation values. Using this processing makes it possible to reduce error in the calculation of the parallax amount, which arises in relation to the brightness distribution of the projected pattern and the positions of the base images. This in turn makes it possible to reduce error in the distance measurement, and highly-accurate distance measurement can therefore be carried out.

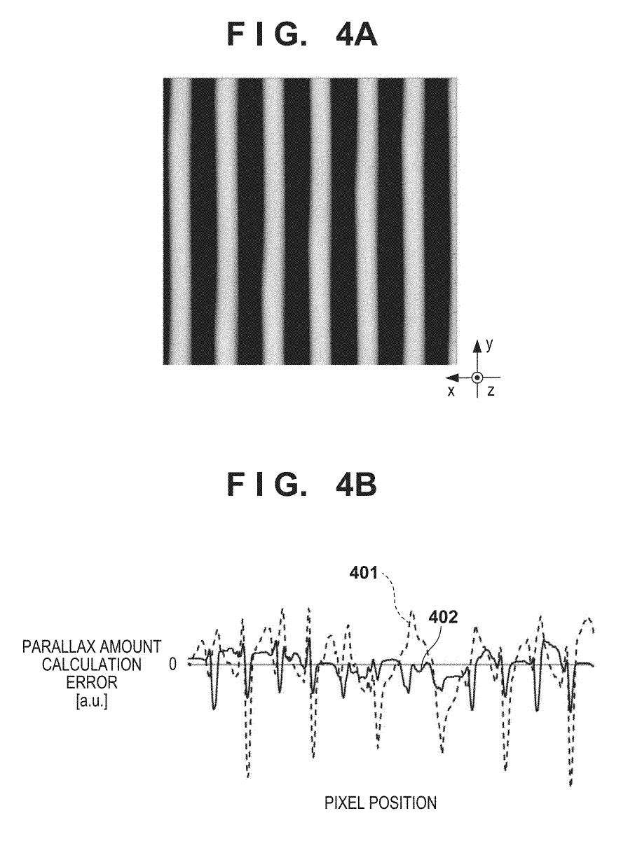

An example of a result of the processing in the distance detection method according to the present embodiment will be described next with reference to FIGS. 4A and 4B. FIG. 4A is an image captured by the image capturing device 103 when the projection device 101 is used to project patterned light onto a flat plate arranged parallel to the image capturing device 103 at a known distance. FIG. 4B is a result indicating error when the parallax amount is calculated at each of positions on the flat plate. In FIG. 4B, the horizontal axis represents the amount of movement (pixel position), and the vertical axis represents parallax amount calculation error. In FIG. 4B, calculation error 401 in the parallax amount calculated using a conventional process is represented by the broken line, whereas calculation error 402 in the parallax amount calculated through the processing according to the present embodiment is represented by the solid line. It can be seen that compared to the conventional method, the method according to the present embodiment brings the error close to 0, i.e., the parallax amount calculation error has been reduced.

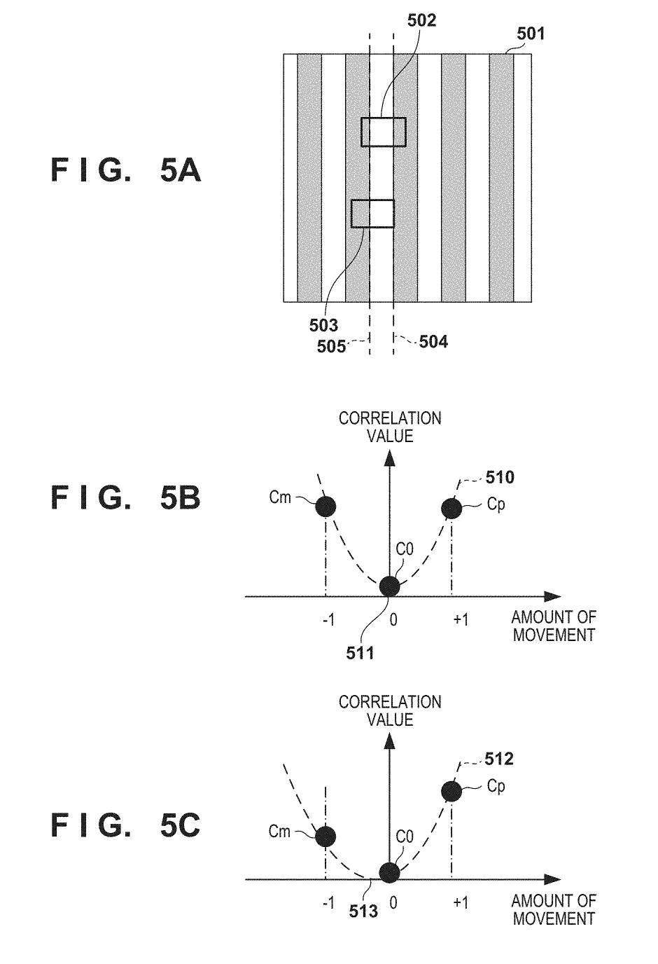

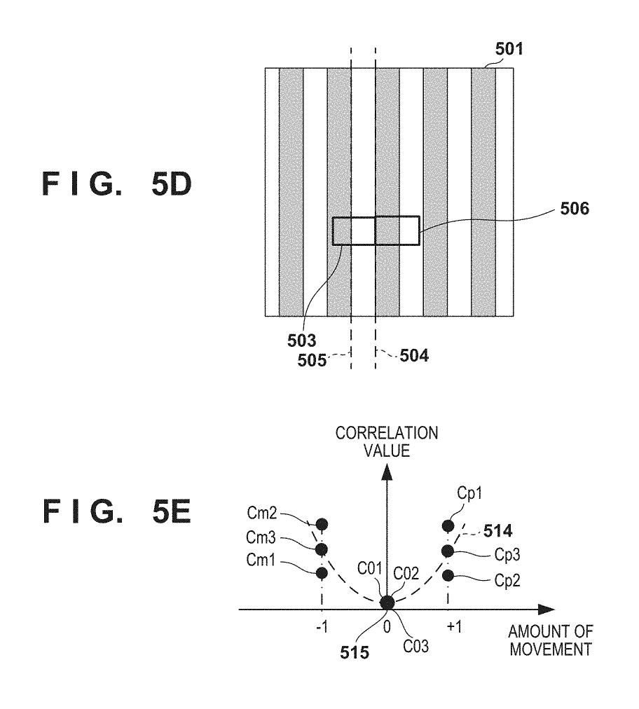

The reason why error arises in the parallax amount calculation in the conventional processing, but the parallax amount calculation error is reduced in the processing according to the present embodiment, will be described next with reference to FIGS. 5A to 5E. The following descriptions assume that the A image and the B image are images having the same contrast, and do not have parallax. FIGS. 5A to 5C are diagrams illustrating a reason why error arises.

FIG. 5A is a diagram illustrating the positional relationship between an A image 501, which has a line pattern in which bright regions and dark regions appear in an alternating manner, and base images 502 and 503. The base image 502 has image edges 504 and 505 (boundary parts), where the bright regions and the dark regions of the A image 501 switch, within the base image 502. FIG. 5B illustrates the correlation values calculated by calculating the correlation between the base image 502 and a referred image set with respect to the base image 502 while moving the referred image. Here, a lower correlation value indicates a higher correlation.

Correlation values C0, Cp, and Cm are correlation values obtained when the position of the referred image is moved by 0, +1, and −1 pixels, respectively. Because it is assumed that the A image and the B image do not have parallax, the images match when the amount of movement is 0, and the correlation value C0 is a low value. When the referred image is moved by +1 pixel or −1 pixel, a difference arises between the base image 502 and the referred image due to the image edges 504 and 505, and thus the correlation values Cp and Cm are higher than the correlation value C0. At this time, the absolute values of the amounts of movement of the referred image are the same for the correlation values Cp and Cm, which means that the same amount of difference is present between the images due to the image edges 504 and 505 in the line pattern. As such, the correlation value Cp and the correlation value Cm are the same value. These correlation values are interpolated to find a correlation curve 510, the amount of movement (parallax amount) at which the correlation value is the highest is calculated to find a parallax amount 511, and the correct value (a parallax amount of 0) is found.

On the other hand, in the base image 503, the image edge 504 overlaps with the right end of the base image 503. FIG. 5C illustrates the correlation values calculated by calculating the correlation between the base image 503 and a referred image set with respect to the base image 503 while moving the referred image. When the amount of movement is 0, the images match, and the correlation value C0 is a low value. When the amount of movement is +1 pixel, the correlation value Cp is higher than the correlation value C0, as is the case with the base image 502. However, when the amount of movement is −1 pixel, a difference arises between the base image and the referred image due to the image edge 505 only, and thus the correlation value Cm is higher than the correlation value C0 by only an extremely small amount. For this reason, the correlation values in this case are asymmetrical with respect to the + and − sides of the amounts of movement in the referred image. A parallax amount 513 found from a correlation curve 512 obtained by interpolating these correlation values is different from the correct value (a parallax amount of 0), which means that error has arisen. This becomes parallax amount calculation error arising in relation to the brightness distribution of the projected pattern and the positions of the base images.

A reason why parallax amount calculation error is reduced by setting the second base image at a different position in the parallax calculation direction from the first base image, and calculating the parallax amount from correlation values calculated using both the first base image and the second base image, as per the present embodiment, will be described next. FIG. 5D is a diagram illustrating the positions of the A image 501, a first base image 503, and a second base image 506. FIG. 5E illustrates the correlation values calculated using the first base image 503 and the second base image 506.

The first base image 503 is assumed to be a base image in which the image edge 504 overlaps with the right end of the base image, in the same manner as described earlier. First correlation values Cm1, C01, and Cp1 calculated from the first base image 503 are the same as the correlation values Cm, C0, and Cp indicated in FIG. 5C.

Next, the second base image 506 is set so that the left end of the second base image 506 overlaps with the image edge 504. At this time, the positional relationship between the second base image 506 and the image edge 504 is the inverse of the positional relationship between the first base image 503 and the image edge 504. For this reason, second correlation values Cm2, C02, and Cp2 obtained using the second base image 506 are the inverse of the first correlation values Cm1, C01, and Cp1 obtained using the first base image 503, as indicated in FIG. 5E.

Finding the arithmetic mean of these correlation values for each referred image position (amount of movement) produces correlation value such as third correlation values Cm3, C03, and Cp3. The third correlation values cancel the asymmetry between the + and − sides of the amounts of movement of the referred images, and are therefore symmetrical. In this case, a parallax amount 515 found from a correlation curve 514 obtained by interpolating the correlation values is a correct value (a parallax amount of 0), and thus an appropriate parallax amount can be calculated. With the processing according to the present embodiment, the parallax amount calculation error can be reduced on the basis of this principle, and thus highly-accurate distance measurement can be carried out on the basis of the appropriately-calculated parallax amount.

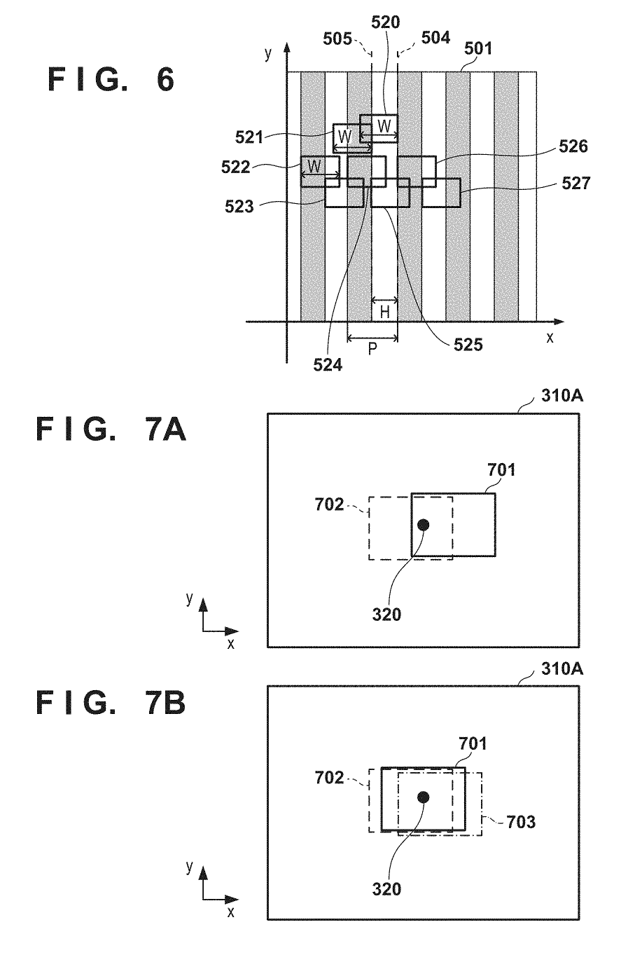

Here, in the distance detection method according to the present embodiment, varying the positions of the first base image and the second base image in the parallax calculation direction by an appropriate amount makes it possible to reduce parallax amount calculation error. FIG. 6 is a diagram illustrating appropriate positions for the base images.

A first base image 520 and a first base image 521 are base images in which the right ends of the base images overlap with the image edge 504 or the image edge 505 of the A image 501. Error arising in the correlation values when using the first base images 520 and 521 is thought to be canceled out by the correlation value calculated using the second base image.

In this case, the second base image may be set so that error arises in the correlation value due to the image edge at the left end of the second base image, so as to cancel out error in the correlation value due to the image edge at the right end of the first base image. Accordingly, the second base image may be set so that the left end of the second base image overlaps with the image edge present in the A image 501 near the first base images 520 and 521.

For example, as illustrated in FIG. 6, the second base image can be set to any one of the second base images 522, 523, 524, 525, 526, and 527. At this time, when the differences in the positions between the first base image 520 or the first base image 521 and each of the second base images 522, 523, 524, 525, 526, and 527 are found with respect to the x-axis direction, the differences in the positions can be expressed using the following Expression (1a) or Expression (1b).

ΔX1=|W−n·P| (1a)

ΔX2=|W−H−n·P| (1b)

Here, W represents the widths of the first base image and the second base image in the x direction (the parallax calculation direction), P represents the period of the projected pattern in the captured image, H represents the width of a high-brightness region of the projected pattern in the captured image, and n represents a given integer.

With the distance detection method according to the present embodiment, the positions of the first base image and the second base image are made different from each other, with respect to the parallax calculation direction, by the amount indicated by Expression (1a) or Expression (1b). This makes it possible to most appropriately reduce the parallax amount calculation error, and carry out the distance measurement with a high level of accuracy.

Note that the position of the second base image in a direction perpendicular to the parallax calculation direction (the y-axis direction) may be set to a different position from the first base image. Additionally, the positions of the first base image and the second base image in the x-axis direction or the y-axis direction can be set to be as close to each other as possible. Having the positions of the first base image and the second base image close to each other makes it possible to set both base images to regions where the distance to the object is substantially the same, which makes it possible to more appropriately reduce parallax amount calculation error.

The image obtained by the distance detection device 100 has image height dependence, due to illumination unevenness in the projection device 101, aberration in the image forming optical system 104, and so on. From this perspective as well, the positions of the first base image in the second base image in the x-axis direction and the y-axis direction can be set close to each other. In one embodiment, assuming that the length between opposing corners of the captured image is 1, the first base image and the second base image are at a distance of 0.1 or less, and in another embodiment, a distance of 0.05 or less. Setting the positions of the first and second base images in this manner makes it possible to more appropriately reduce parallax amount calculation error.

As described above, the distance detection device according to the present embodiment includes the projection device 101, the image capturing device 103, and the calculation processing unit 106, which includes the correlation calculation unit 161, the parallax calculation unit 162, and the distance calculation unit 163. The projection device 101 projects the patterned light onto the object 102. The image capturing device 103 obtains an image pair having parallax using the patterned light projected from the projection device 101. The correlation calculation unit 161 sets a base image in one of the images of the obtained image pair, and calculates a correlation value for the image pair on the basis of the base image. More specifically, the correlation calculation unit 161 sets a referred image in the other of the images in the image pair, and calculates a correlation value between the base image and the referred image while moving the position of the referred image in a prescribed direction. The parallax calculation unit 162 calculates a parallax amount in the image pair using the correlation values calculated by the correlation calculation unit 161. The distance calculation unit 163 calculates the distance to the object 102 using the parallax amount calculated by the parallax calculation unit 162.

More specifically, the correlation calculation unit 161 sets a first base image in one of the images in the image pair, and calculates a first correlation value on the basis of the first base image. The correlation calculation unit 161 then sets a second base image in the one image in the image pair, at a position different from the position of the first base image with respect to the parallax calculation direction, and calculates a second correlation value on the basis of the second base image. The parallax calculation unit 162 then calculates the parallax amount using the first correlation value and the second correlation value.

Here, the correlation calculation unit 161 sets the first base image and the second base image in accordance with Expression (1a) or Expression (1b). More specifically, the correlation calculation unit 161 sets the first base image and the second base image to different positions in the parallax calculation direction, by an amount equivalent to the width of the first base image in the parallax calculation direction, or an amount equivalent to a difference between that width and the period of the patterned light in the captured image. Alternatively, the correlation calculation unit 161 sets the first base image and the second base image to different positions in the parallax calculation direction, by an amount equivalent to a difference between the width of the first base image in the parallax calculation direction and the width of a high-brightness region in the patterned light in the captured image. As yet another alternative, the correlation calculation unit 161 sets the first base image and the second base image to different positions in the parallax calculation direction by an amount obtained by subtracting the width of a high-brightness region in the patterned light in the captured image and the period of the patterned light from the width of the first base image in the parallax calculation direction.

Additionally, the parallax calculation unit 162 calculates the parallax amount from a correlation value obtained by adding, or finding the arithmetic mean of, the first correlation value and the second correlation value.

According to this configuration, the distance detection device 100 can reduce the parallax amount calculation error when detecting a distance using an image obtained by capturing projected patterned light. Accordingly, the distance detection device 100 can obtain highly-accurate distance information of the object 102 on the basis of the parallax amount, which has a reduced amount of calculation error.

Although the flow of the distance detection process according to the present embodiment describes carrying out correlation calculation 2 after correlation calculation 1, the first base image may be set in correlation calculation 1, after which correlation calculation 1 and correlation calculation 2 are processed in parallel.

Additionally, the method for calculating the parallax amount in the present embodiment is not limited to the method mentioned above in S304. For example, the parallax calculation unit 162 may calculate a first parallax amount using the first correlation value, calculate a second parallax amount using the second correlation value, and then find an arithmetic mean of these parallax amounts to calculate a final parallax amount. In this case, the correlation calculation unit 161 need not find the third correlation value using the first and second correlation values.

Furthermore, a first base image 701 and a second base image 702 may, in the A image 310A, be shifted in opposite directions from each other with respect to the parallax calculation direction, central to the pixel of interest 320, as illustrated in FIG. 7A. Even in this case, the first base image 701 and the second base image 702 are used to calculate average distance information for a partial region centered on the pixel of interest 320, and skew between the position of the pixel of interest 320 and the position of the distance information can therefore be reduced. Additionally, by appropriately setting the positional relationship between the first base image 701 and the second base image 702 with respect to the parallax calculation direction as described above, parallax amount calculation error can be more appropriately reduced.

The present embodiment describes a method for calculating the parallax amount by setting two base images, namely the first base image and the second base image. However, many other base images may furthermore be set in the periphery of the first base image, and the parallax amount may be calculated using correlation values calculated for each of the base images.

For example, as illustrated in FIG. 7B, the correlation calculation unit 161 may set the first base image 701, the second base image 702, and a third base image 703, and may calculate the first correlation value, the second correlation value, and the third correlation value using the respective base images. Then, the parallax calculation unit 162 may calculate the parallax amount from a correlation value obtained by adding, or finding the arithmetic mean of, these correlation values, in the same manner as described above. Additionally, the parallax calculation unit 162 may calculate a parallax amount using a correlation value found by adding the first correlation value and the second correlation value, calculate a parallax amount using a correlation value found by adding the first correlation value and the third correlation value, and then calculate a final parallax amount by finding the arithmetic mean of those parallax amounts.

Even if the first base image and the second base image have been set at the same image edge, variations in the brightness of the projected pattern, noise imparted on the captured image, aberration, and so on may result in the first correlation value and the second correlation value being in a relationship that is not perfectly symmetrical. However, by setting more base images and calculating the parallax amount using correlation values found from those base images, the influence of these issues can be reduced, which makes it possible to further reduce parallax amount calculation error. Accordingly, carrying out the stated processing makes it possible to more appropriately measure a distance at a high level of accuracy.

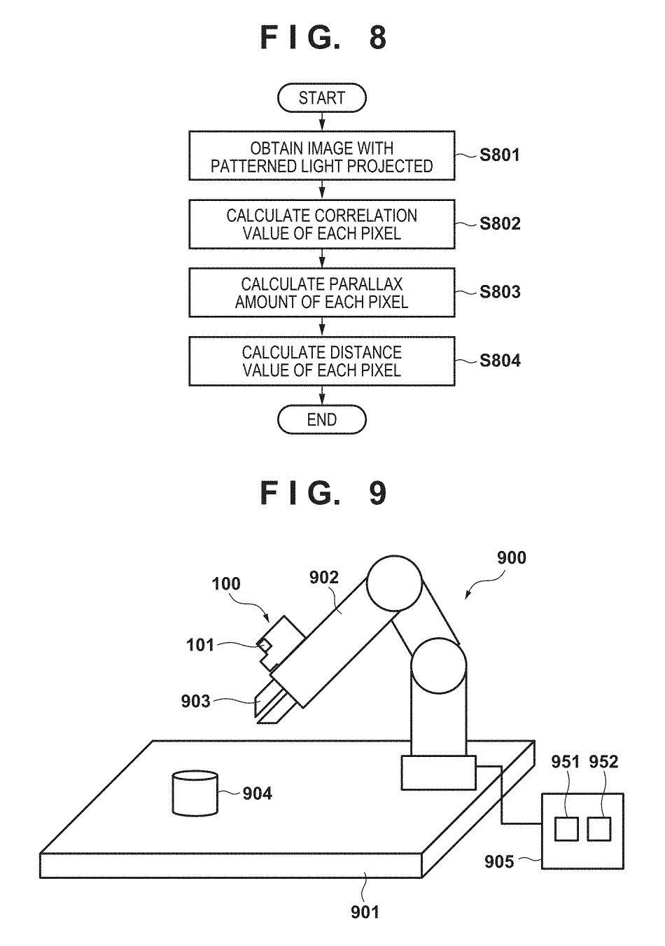

Furthermore, the present embodiment describes a case where the distance to the object 102 is calculated for a single pixel of interest. In contrast to this, FIG. 8 illustrates the flow of a distance detection method that efficiently calculates a distance (a range image) for a plurality of pixels in the A image. When this distance detection method is started, the process moves to S801.

In S801, “obtain image with patterned light projected”, the image capturing device 103 captures an image in a state where the projection device 101 projects patterned light onto the object 102, and the captured image is stored in the main memory 107, in the same manner as S301.

Next, in S802, “calculate correlation value for each pixel”, the correlation calculation unit 161 calculates a correlation value for each pixel in the A image. Specifically, a partial region in the A image containing a pixel of interest and pixels in the periphery thereof is extracted and set as a base image. Next, the referred image is set in the B image, the position where the referred image is extracted is moved in the parallax calculation direction, and the correlation value between the referred image and the base image is calculated every amount of movement in order to calculate a correlation value for every amount of movement. This calculation is carried out while setting each pixel in the A image as the pixel of interest, and thus a correlation value is calculated for each pixel.

In S803, “calculate parallax amount for each pixel”, the parallax calculation unit 162 calculates a parallax amount for each pixel in the A image. Thereafter, the parallax calculation unit 162 selects a pixel that is different, with respect to the parallax calculation direction, from the pixel of interest in the A image by a prescribed position. At this time, the parallax calculation unit 162 selects a pixel corresponding to the pixel of interest in the second base image, which is set to be different by a suitable position from the first base image including the pixel of interest, as described above. The parallax calculation unit 162 then selects the correlation value calculated in S802 for the pixel of interest and the selected pixel, and calculates the parallax amount using the selected correlation values. Note that the parallax amount can be calculated using the same method as that of S304.

In S804, “calculate distance value for each pixel”, the distance calculation unit 163 calculates a distance value for each pixel in the A image. Specifically, the distance calculation unit 163 converts the parallax amount calculated for each pixel in S803 into a defocus amount or an object distance using the same known method as in S305.

Using this flow makes it possible to reduce the number of redundant correlation calculations compared to a case where the correlation value is calculated by setting a plurality of base images for each pixel of interest, and thus the distance (a range image) can be calculated efficiently for a plurality of pixels.

As another example, after the correlation calculation unit 161 calculates the correlation value for each pixel in S802, the parallax calculation unit 162 calculates a temporary parallax amount for each pixel using the stated correlation values. Then, in S803, the parallax calculation unit 162 may use the parallax amounts for the pixels calculated in S802 to calculate a final parallax amount, by finding the arithmetic mean of the parallax amount of a pixel at the above-described appropriate different position from the pixel of interest, and the parallax amount of the pixel of interest. A distance can be efficiently calculated for a plurality of pixels in this case as well. Note that the temporary parallax amount may be calculated in S803.

Note that the projected pattern emitted onto the object 102 by the projection device 101 can be a line pattern in which high-brightness regions and low-brightness regions extend in a direction perpendicular to the parallax calculation direction. If the projected pattern is tilted at an angle relative to the direction perpendicular to the parallax calculation direction, there will be fewer spatial frequency components in the parallax calculation direction (the pupil division direction) and the captured image, which causes a drop in the accuracy of the correlation calculation and a corresponding drop in the accuracy of the parallax amount calculation.

Accordingly, in an embodiment, an angle formed between the parallax calculation direction and the direction in which bright regions in the projected pattern extend is greater than or equal to 60°, and in another embodiment, greater than or equal to 80°. A more accurate distance measurement can be carried out by projecting a pattern in which high-brightness regions (illuminated regions) extend in a direction close to a direction perpendicular to the parallax calculation direction and calculating the parallax amount through the method described in the present embodiment.

Additionally, in the present embodiment, the second base image is set in the vicinity of the first base image, and the parallax amount is calculated using correlation values calculated from the base images. As such, in one embodiment, identical patterns are close to each other in the projected pattern to the greatest extent possible. To that end, in one embodiment, the projected pattern is a periodic pattern in which the brightness distribution is repeated in a periodic manner. If at this time the pattern is a perfectly periodic pattern, there are cases where a region shifted by a single period is mistakenly detected when calculating the parallax amount through correlation calculation. Limiting the range in which to search for the parallax amount (the amount by which the referred images move) to a range smaller than the period of the pattern makes it possible to avoid such erroneous detection.

It is not necessary for the projected pattern to be a pattern in which the same brightness distribution is repeated. The projected pattern may be any pattern in which substantially the same brightness distribution is repeated periodically. For example, the width of bright regions with respect to the parallax calculation direction may differ from line to line. The pattern may be a pattern in which the brightness within bright regions or dark regions varies. Providing a suitable amount of variation in the brightness makes it possible to avoid a situation where a region shifted by one period is erroneously detected.

Furthermore, the image capturing device that obtains a parallax image may be constituted by a stereo camera including two or more optical systems and corresponding image sensors. In this case, the baseline length can be designed with more freedom, and the resolution of the distance measurement can be improved. Additionally, the distance detection device may be configured as a device separate from the image capturing device and the projection device.

If the control device is configured using a central processing unit (CPU) or the like provided within the image capturing device, the device as a whole can be made smaller.

Additionally, the projection device 101 may use a laser diode (LD) as its light source. Furthermore, reflective liquid crystal on silicon (LCOS), transmissive LCOS, a digital micromirror device (DMD), or the like may be used as the pattern forming means. Using these makes it possible to vary the period of the projected pattern as desired in accordance with the size, distance, and so on of the object, which makes it possible to carry out more accurate distance measurement based on the conditions.

Furthermore, using white light, in which the light wavelength contains the entire spectrum of visible light, as the light from the light source of the projection device 101 provides a reflectance correction effect that does not depend on the spectral reflectivity of the object 102. Furthermore, from the standpoint of using light efficiently to conserve energy, the light source of the projection device 101 can be configured including three colors, i.e., RGB, and the wavelengths of the light from the light source can then be matched to the color filter transmission bands of the image capturing device 103.

If the wavelength of the light source of the projection device 101 is in the infrared (IR) range, images can be captured by using an image capturing device 103 including color filters and an image sensor 105 having corresponding transmission bands and photosensitivity. In this case, an image for observation can be captured at the same time by using the RGB bands. In particular, when the IR wavelength band is from 800 nm to 1100 nm, Si can be used for the photoelectric conversion units in the image sensor. Then, by changing the arrangement of the color filters, an RGB observation image and an IR distance measurement image can be obtained using a single image sensor.

Although the present embodiment describes an example in which the distance to the object 102 is calculated, the method of calculating the parallax amount according to the present embodiment can also be applied in a parallax detection device that detects a parallax amount. In this case, S305 in FIG. 3A, “distance value calculation”, may be omitted. For example, the parallax detection device can carry out a process for cutting out an object near a focal position from an image on the basis of the parallax amount. If the parallax amount detection device is configured in the same manner as the distance detection device 100 according to the present embodiment, with the exception of outputting the parallax amount directly without converting the parallax amount into a distance, the rest of the configuration may be the same as that of the distance detection device 100.

In addition to being applied in a distance detection device, the distance detection method according to the present embodiment may be realized as a computer program. Such a computer program causes a computer (processor) to execute prescribed steps in order to calculate a distance or a parallax amount. The program is installed in a computer of a distance detection device, a parallax detection device, or an image capturing device such as a digital camera that includes one of the stated devices. In this case, the above-described functions can be realized by the computer executing the installed program, and highly-accurate distance detection or parallax amount detection can therefore be carried out.

### Second Embodiment

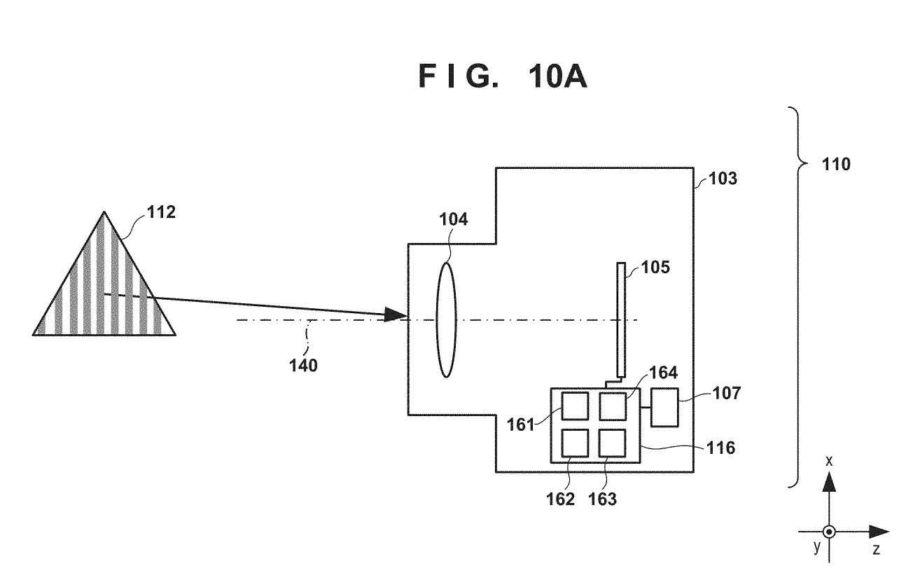

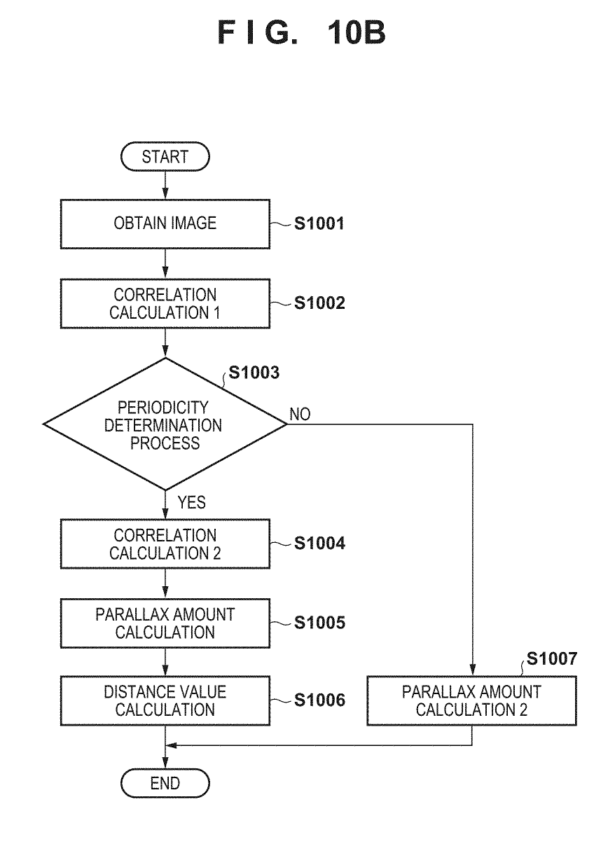

A robot device according to a second embodiment, such as an industrial robot device, will be described next with reference to FIG. 9. A robot device 900 according to the present embodiment is provided with: a pedestal 901; a robot arm 902, which is an articulated robot arm; a robot hand 903; a control device 905; and the distance detection device 100. Note that the distance detection device 100 according to the present embodiment is the same as the distance detection device 100 according to the first embodiment. As such, the same reference signs will be used, and descriptions thereof will be omitted.

The robot arm 902 is installed on the pedestal 901, and the robot hand 903 is attached to a tip part of the robot arm 902. The robot hand 903 can grip a workpiece (industrial component) 904 and attach the gripped workpiece 904 to another component.

The distance detection device 100 is fixed to the tip part of the robot arm 902 so that the workpiece 904 is within the image capturing range. Note that the distance detection device 100 may be fixed using any desired method, and may be configured to be removable as well. The distance detection device 100 transmits image information, distance information, and so on obtained by capturing an image to the control device 905.

The control device 905 controls the robot arm 902, the robot hand 903, the distance detection device 100, and the like. The control device 905 is provided with a calculation unit 951 and a control unit 952.

The calculation unit 951 estimates the position and attitude of the workpiece 904, calculates driving amounts for the robot arm 902 and the robot hand 903, and so on based on the distance information, image information, and so on sent from the distance detection device 100. The control unit 952 controls the driving of the robot arm 902 and the robot hand 903 on the basis of the timing at which a command to detect the distance is sent to the distance detection device 100, calculation results from the calculation unit 951, and so on.

Note that the control device 905 may be constituted by a given computer, and the constituent elements of the control device 905 can be constituted by software modules executed by a calculation device such as a CPU, an MPU, or the like. Likewise, the constituent elements of the control device 905 may be constituted by circuits that realize specific functions, such as ASICs.

In a manufacturing process using the robot device 900, the workpiece 904, which is arranged on the pedestal 901, is gripped by the robot hand 903. Accordingly, the control unit 952 sends movement commands to the robot arm 902 over a serial communication path, and controls the robot arm 902 and the robot hand 903 so that the robot hand 903 moves to the vicinity of the workpiece 904.

The position and attitude of the workpiece 904 vary, and thus before the robot hand 903 grips the workpiece 904, the robot device 900 uses the distance detection device 100 to capture an image of the workpiece 904, and obtains the image information and the distance information. The calculation unit 951 of the control device 905 calculates position and attitude information of the workpiece 904 on the basis of the image information and the distance information, and estimates the position and attitude of the workpiece 904. Furthermore, the calculation unit 951 calculates an amount of movement of the robot arm 902 on the basis of the calculated position and attitude information of the workpiece 904. The calculation unit 951 sends data of the calculated amount of movement of the robot arm 902 to the control unit 952.

The control unit 952 sends a command to the robot arm 902 to move by the amount of movement received from the calculation unit 951. As a result, the robot arm 902 moves to a position suitable for gripping the workpiece 904. Once the movement of the robot arm 902 is complete, the control unit 952 sends a command to close the robot hand 903. The robot hand 903 closes in response to the command from the control unit 952, thereby gripping the workpiece 904.

The control unit 952 moves the robot arm 902 to a prescribed position in order to assemble the workpiece 904 gripped by the robot hand 903 with a main component (not shown), and sends a command to open the robot hand 903 after this movement. Operations for attaching the workpiece 904 are carried out by the robot device 900 by repeating this series of operations.

A typical workpiece 904 does not have a pattern on its surface. As such, with the robot device 900, patterned light is projected from the projection device 101 of the distance detection device 100, and an image is captured of the workpiece 904 in a state where a texture is superimposed on the surface of the workpiece 904. This makes it possible to measure the distance with a high level of accuracy.

As in the first embodiment, the distance detection device 100 appropriately sets a first base image and a second base image, calculates a parallax amount from correlation values calculated using these base images, and finds a distance. This makes it possible to obtain the distance information of the workpiece 904 at a higher level of accuracy. As a result, with the robot device 900, the estimation accuracy of the position and attitude of the workpiece 904 is improved, and the accuracy of the positional control of the robot arm 902 and the robot hand 903 is improved as well, which makes it possible to carry out assembly operations with a higher level of accuracy.

As described above, the robot device 900 according to the present embodiment includes: the distance detection device 100; the robot arm 902; the robot hand 903 provided on the robot arm 902; and the control device 905 that controls the robot arm 902 and the robot hand 903. Here, the distance detection device 100 obtains the distance information, which includes the distance to the workpiece 904, and the image information of the workpiece 904. The control device 905 estimates the position and attitude of the workpiece 904 using the distance information and the image information, and controls the robot arm 902 and the robot hand 903 on the basis of the estimated position and attitude. According to this configuration, with the robot device 900, parallax amount calculation error can be reduced, and by obtaining the distance information of the workpiece 904 at a higher level of accuracy, the accuracy at which the position and attitude of the workpiece 904 is estimated can be improved, and more accurate assembly operations can be carried out.

Although the present embodiment describes an example in which the distance detection device 100 is fixed to the robot arm 902, the distance detection device 100 may be provided in a position distanced from the robot arm 902. In this case, the distance detection device 100 may be installed in any position where the workpiece 904 enters into the image capturing range. Additionally, the calculation processing unit 106 need not be provided within the distance detection device 100, and may instead be provided within the control device 905. Additionally, the processing carried out by the calculation processing unit 106 may instead be carried out by the calculation unit 951 in the control device 905.

The distance between the distance detection device 100 and the workpiece 904 varies depending on the position of the robot arm 902, the robot hand 903, and so on. If the distance detection is carried out without changing the projected pattern of the projection device 101, the period of the pattern in the captured image will vary depending on the distance between the distance detection device 100 and the workpiece 904. The optimal positional relationship between the first base image and the second base image will therefore change, and the effect of reducing parallax amount calculation error may become weaker as a result.

Accordingly, the correlation calculation unit 161 may analyze the image obtained by capturing an image of the projected pattern and set the position of the second base image on the basis of the analysis result. Specifically, the correlation calculation unit 161 analyzes an image pair obtained by capturing images of the projected pattern, and calculates/evaluates a period of variations in pixel values expressing the period of the pattern in the images. Next, on the basis of the width of the first base image in the parallax calculation direction and the period of the pattern, the correlation calculation unit 161 determines a position where the second base image is to be set. At this time, the correlation calculation unit 161 can determine the position of the second base image in accordance with the above-described Expression (1a) or Expression (1b). Through this processing, the correlation calculation unit 161 can appropriately set the position of the second base image in accordance with the distance between the distance detection device 100 and the workpiece 904.

Additionally, as the distance between the workpiece 904 and the robot hand 903 decreases, the distance information having a higher in-plane resolution is obtained, and there is demand for the position and attitude of the workpiece 904 to be estimated with a higher level of accuracy. Here, the distance to the workpiece 904 can generally be calculated from the size of the workpiece 904 in the captured image. The obtainment of the distance information of the workpiece 904 by the distance detection device 100 and the control of the robot arm 902 by the control device 905 are carried out sequentially in time series, and thus the distance to the workpiece 904 can also generally be known on the basis of the distance information obtained one cycle previous to that processing.

Accordingly, the correlation calculation unit 161 or the calculation processing unit 106 may set the sizes of the first base image and the second base image on the basis of the general distance information of the workpiece 904, so that the sizes of those images decrease as the distance to the workpiece 904 decreases. In this case, the correlation calculation unit 161 can determine the position of the second base image from the period of the projected pattern in the images and the size of the first base image.

Additionally, the projected pattern of the projection device 101 may be changed by the control unit 108 so that the period of the projected pattern becomes finer as the distance to the workpiece 904 decreases. Through this processing, the second base image can be set appropriately in accordance with the distance between the distance detection device 100 and the workpiece 904.

By setting the second base image appropriately through these methods, the robot device 900 can reduce parallax amount calculation error by the distance detection device 100, and the distance to the workpiece 904 can therefore be calculated with a high level of accuracy. As a result, with the robot device 900, the estimation accuracy of the position and attitude of the workpiece 904 is improved, and the accuracy of the positional control of the robot arm 902 and the robot hand 903 is improved as well, which makes it possible to carry out assembly operations with a higher level of accuracy.

### Third Embodiment

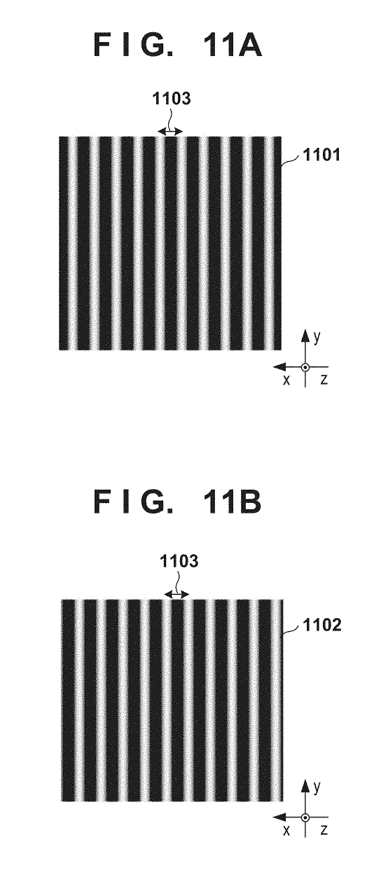

A distance detection device according to a third embodiment of the disclosure will be described hereinafter with reference to FIGS. 10A and 10B. In the distance detection device 100 according to the first embodiment, the projection device 101 is provided, but the configuration of the distance detection device is not limited thereto. In a distance detection device 110 according to the present embodiment, the projection device 101 is not provided, and the distance to an object 112 is detected by analyzing a pattern in the object 112. This distance detection device 110 is particularly useful when detecting the distance to an object 112 having a pattern that changes periodically.

Note that the distance detection device 110 according to the present embodiment has the same configuration as the distance detection device 100 according to the first embodiment, aside from that the projection device 101 is not provided, and that a calculation processing unit 116 includes a determination unit 164. As such, constituent elements aside from the calculation processing unit 116 and the determination unit 164 will be given the same reference signs as in the first embodiment, and descriptions thereof will be omitted. The following descriptions will focus on the difference between the distance detection device 110 according to the present embodiment and the distance detection device 100 according to the first embodiment.

FIG. 10A illustrates an example of the overall configuration of the distance detection device 110 according to the present embodiment. The image capturing device 103 is provided with the image forming optical system 104, the image sensor 105, the calculation processing unit 116, and the main memory 107. The image forming optical system 104, the image sensor 105, and the main memory 107 have the same configurations as in the first embodiment.

The calculation processing unit 116 is provided with the determination unit 164 in addition to the correlation calculation unit 161, the parallax calculation unit 162, and the distance calculation unit 163. The correlation calculation unit 161, the parallax calculation unit 162, and the distance calculation unit 163 have the same configurations as in the first embodiment. The determination unit 164 determines whether or not a captured image obtained of the object 112 has periodicity, and sends a result of the determination to the correlation calculation unit 161. The correlation calculation unit 161 carries out correlation calculation on the basis of the determination result received from the determination unit 164.

The flow of a distance detection method according to the present embodiment will be described next with reference to FIG. 10B. When this distance detection method is started, the process moves to S1001.

In S1001, “obtain image”, the image capturing device 103 captures an image of the object 112, generates and obtains an image pair including the A image and the B image having parallax, and stores the obtained image pair in the main memory 107.

The processing in the steps following thereafter is carried out by the calculation processing unit 116. In S1002, “correlation calculation 1”, the correlation calculation unit 161 sets the first base image and calculates the first correlation value.

Next, in S1003, “periodicity determination process”, the determination unit 164 determines whether the pixel values of the captured image have periodicity in the parallax calculation direction. The periodicity determination is carried out by extracting a partial region image from the A image, and carrying out a correlation calculation between the extracted image and another partial region image in the A image, for example. When regions of high correlation appear periodically, the determination unit 164 can determine that the captured image has periodicity. Additionally, the determination unit 164 may use the first correlation value found by the correlation calculation unit 161 to determine whether or not the correlation value between the first base image and the referred image increases periodically with respect to the amount of movement of the referred image. In this case, the determination unit 164 can determine that the captured image has periodicity if the correlation value increases periodically. If it is determined in S1003 that the captured image has periodicity, the process moves to S1004.

In S1004, “correlation calculation 2”, the correlation calculation unit 161 sets the second base image and calculates the second correlation value. The method for setting the second base image and the method for calculating the second correlation value are the same as in the first embodiment.

In S1005, “parallax amount calculation”, the parallax calculation unit 162 calculates a parallax amount from the first correlation value and the second correlation value found in S1002 and S1004. The method for calculating the parallax amount is the same as in the first embodiment. In the present embodiment, no patterned light is projected, and thus the image edge is the edge of the pattern in the object 112.

In S1006, “distance value calculation”, the distance calculation unit 163 converts the parallax amount calculated in S1005 into a defocus amount or an object distance through a known method, in the same manner as in the first embodiment.

On the other hand, if it is determined in S1003 that the captured image does not have periodicity, the process moves to S1007, “parallax amount calculation 2”. In S1007, the parallax calculation unit 162 calculates the parallax amount from the first correlation value calculated in S1002. The same method as that described above can be used as the method for calculating the parallax amount from the first correlation value. Once the parallax amount has been calculated in S1007, the distance calculation unit 163 calculates the distance value in S1006 on the basis of the calculated parallax amount.

Through such processing, the distance detection device 110 according to the present embodiment can reduce parallax amount calculation error and carry out highly-accurate distance detection for the same reasons as described in the first embodiment, even for an object 112 that has a periodically-varying pattern.

As described above, the distance detection device 110 according to the present embodiment includes the determination unit 164, which determines whether one of the images in the image pair obtained by the image capturing device 103 has periodicity in the parallax calculation direction. If it is determined that one of the images in the image pair has periodicity in the parallax calculation direction, the correlation calculation unit 161 calculates the first correlation value and the second correlation value, and the parallax calculation unit 162 calculates the parallax amount using the first correlation value and the second correlation value. Accordingly, the distance detection device 110 can reduce parallax amount calculation error, and can carry out highly-accurate distance measurement, on the basis of the periodically-varying pattern of the object 112, even without the patterned light being projected.

Note that the distance detection device according to the present embodiment may be applied in a robot device, in the same manner as in the second embodiment. In such a case, the distance to the workpiece can be calculated with a high level of accuracy. As such, the accuracy with which the position and attitude of the workpiece is estimated can be improved. This makes it possible to improve the accuracy of the control of the positions of the robot arm and robot hand, and makes it possible to carry out more accurate assembly operations.

The parallax detection method and the distance detection method according to the present embodiment may be applied in a parallax detection device for outputting a detected parallax amount, in the same manner as in the first embodiment. In this case, too, parallax amount detection error can be reduced for an object having a periodically-varying pattern.

### Fourth Embodiment

In the first embodiment, base images are set at different locations, in the parallax calculation direction, in an image obtained by capturing light of a single projected pattern, and a distance is detected by calculating a correlation value with a referred image for each of the base images. In contrast to this, in a distance detection device according to a fourth embodiment, base images are set at the same location in two image pairs obtained by capturing images of the light of two projected patterns shifted from each other in the parallax calculation direction, and a distance is detected by calculating a correlation value with a referred image for each of the base images.

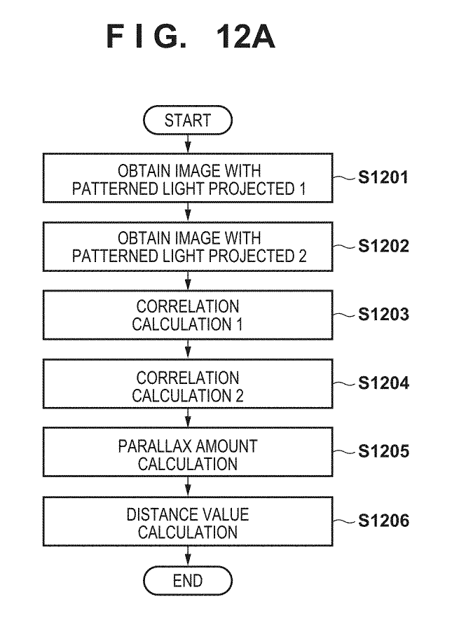

The distance detection device according to the present embodiment will be described hereinafter with reference to FIGS. 11A through 15B. The configuration of the distance detection device according to the present embodiment is the same as the configuration of the distance detection device 100 according to the first embodiment, and thus the same reference signs as in the first embodiment will be assigned, and descriptions will be omitted as appropriate. The following descriptions will focus on the difference between the distance detection device according to the present embodiment and the distance detection device 100 according to the first embodiment.

FIGS. 11A and 11B illustrate the patterned light projected in the present embodiment. Patterned light 1101, which serves as first patterned light, has a period 1103 in which high-brightness regions and low-brightness regions repeat in an alternating manner in the x-axis direction. The patterned light 1101 has a line pattern in which the brightness regions extend in the y-axis direction. Patterned light 1102, which serves as second patterned light, has the same periodic brightness distribution in the x-axis direction as the patterned light 1101, and has a line pattern in which the brightness regions extend in the y-axis direction. The position of the line pattern of the patterned light 1102 is shifted in the x-axis direction with respect to the position of the line pattern of the patterned light 1101.

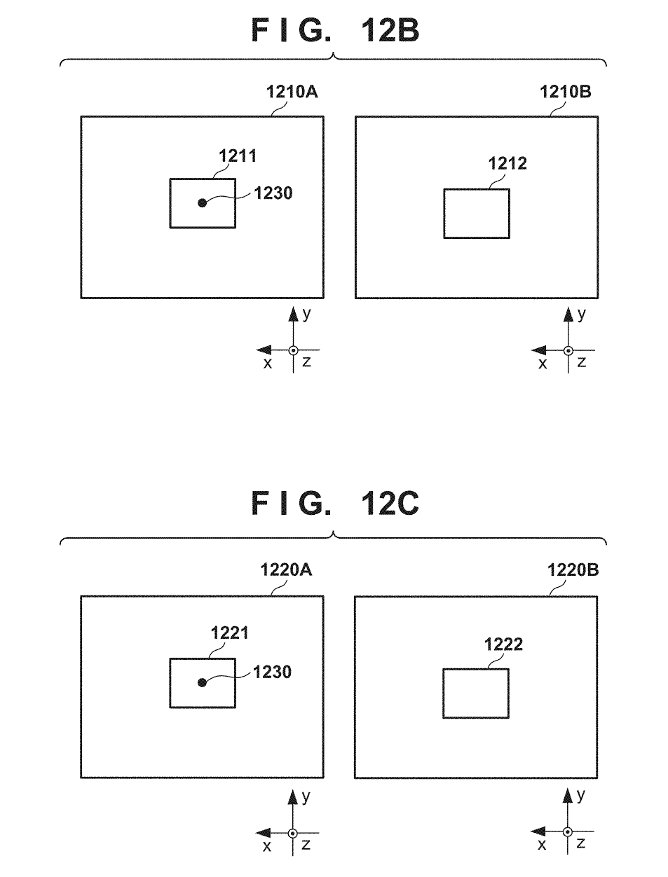

The flow of the distance measurement calculation according to the present embodiment will be described next with reference to FIGS. 12A to 12C. FIG. 12A is a flowchart illustrating the distance detection process according to the present embodiment, and FIGS. 12B and 12C are diagrams illustrating the correlation calculation carried out by the correlation calculation unit 161. When the distance detection process according to the present embodiment is started, the process moves to S1201.

In S1201, “obtain image with patterned light projected 1”, an image is captured using the image capturing device 103 in a state where the patterned light 1101 is projected onto the object 102 by the projection device 101, and the captured image is stored in the main memory 107. Note that the method for projecting the patterned light is the same as in the first embodiment, and will therefore not be described.

In S1202, “obtain image with patterned light projected 2”, an image is captured in a state where the patterned light 1102 is projected onto the object 102, and the captured image is stored in the main memory 107. The method for projecting the patterned light is the same as in the first embodiment, and will therefore not be described.

The processing from S1203 to S1206 is carried out by the calculation processing unit 106. Here, FIGS. 12B and 12C are diagrams illustrating the positional relationship between the base image and the referred image set in S1203 and S1204, respectively. FIG. 12B illustrates an A image 1210A and a B image 1210B obtained in S1201, and FIG. 12C illustrates an A image 1220A and a B image 1220B obtained in S1202. Hereinafter, a pixel used for distance calculation, located at the same position in the A image 1210A and the A image 1220A, will be described as a pixel of interest 1230.

In S1203, “correlation calculation 1”, the correlation calculation unit 161 calculates a first correlation value using the image pair obtained in S1201. Specifically, first, the correlation calculation unit 161 extracts a partial region of the A image 1210A, containing the pixel of interest 1230 and the pixels in the periphery thereof, and sets that partial region as a first base image 1211. Next, the correlation calculation unit 161 extracts a region, in the B image 1210B, having the same area (image size) as the first base image 1211, and sets that region as a referred image 1212. The correlation calculation unit 161 then moves the position in the B image 1210B from where the referred image 1212 is extracted in the same x-axis direction as the pupil division direction, and calculates a correlation value between the referred image 1212 and the first base image 1211 every given amount of movement (at each position). In this manner, the correlation calculation unit 161 calculates the first correlation value from a data string of correlation values corresponding to each amount of movement.

Note that the method for calculating the correlation value may be the same as that in S302 according to the first embodiment. Additionally, the correlation calculation unit 161 can set the referred image 1212 as an image having the same vertical and horizontal dimensions as the first base image 1211.

Next, in S1204, “correlation calculation 2”, the correlation calculation unit 161 calculates a second correlation value using the image pair obtained in S1202. Specifically, first, the correlation calculation unit 161 extracts a partial region of the A image 1220A, containing the pixel of interest 1230 and the pixels in the periphery thereof, and sets that partial region as a second base image 1221. Next, the correlation calculation unit 161 extracts a region, in the B image 1220B, having the same area as the second base image 1221, and sets that region as a referred image 1222. After this, the correlation calculation unit 161 moves the position of the referred image 1222 in the parallax calculation direction and calculates a correlation value with the second base image 1221, in the same manner as in S1203, to calculate a second correlation value constituted by a data string of the correlation values corresponding to every amount of movement. The setting conditions and the like for the referred images 1212 and 1222 may be the same as in the first embodiment.

In S1205, “parallax amount calculation”, the parallax calculation unit 162 calculates a parallax amount using the first correlation value and the second correlation value found in S1203 and S1204, in the same manner as in S304 according to the first embodiment. Specifically, the parallax calculation unit 162 calculates a third correlation value by adding, or finding the arithmetic mean of, the first correlation value and the second correlation value from every amount of movement, and calculates the parallax amount on the basis of the third correlation value. Additionally, in S1206, “distance value calculation”, the distance calculation unit 163 calculates a distance to the object 102 by converting the parallax amount into a defocus amount or an object distance through a known method, in the same manner as in S305 according to the first embodiment.

In this manner, with the distance detection method according to the present embodiment, the first base image 1211 and the second base image 1221 are set for the first image pair and the second image pair, which have different line patterns with respect to the pupil division direction (the parallax calculation direction). Then, a correlation value is calculated between the first base image 1211 and the referred image 1212 set for the first base image 1211, a correlation value is calculated between the second base image 1221 and the referred image 1222 set for the second base image 1221, and the parallax amount is calculated from these correlation values. According to this process, the first correlation value and the second correlation value are calculated from the respective image pairs, and the parallax amount is calculated from the correlation values. This makes it possible to reduce distance measurement error arising in relation to the brightness distribution of the projected patterns and the positions of the base images, which in turn makes it possible to carry out highly-accurate distance measurement.

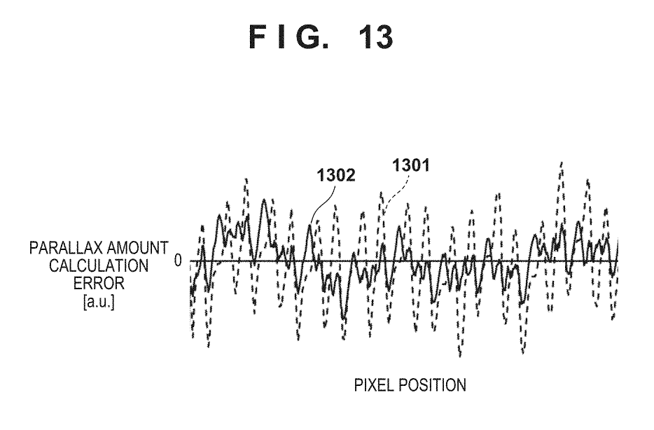

An example of a result of the processing in the distance detection method according to the present embodiment will be described next with reference to FIG. 13. FIG. 13 is a graph illustrating a result of calculating the parallax amount at each of positions on a flat plate, when the projection device 101 is used to project patterned light onto the flat plate, which is arranged parallel to the image capturing device 103 at a known distance, and that pattern is captured by the image capturing device 103. In FIG. 13, the horizontal axis represents the amount of movement (pixel position), and the vertical axis represents parallax amount calculation error. In FIG. 13, calculation error 1301 in the parallax amount calculated from an image pair obtained by projecting only the first patterned light and using a conventional process is represented by the broken line, whereas calculation error 1302 in the parallax amount calculated through the method according to the present embodiment is represented by the solid line. It can be seen that compared to the conventional method, the method according to the present embodiment brings the amount of error close to 0, i.e., the parallax amount calculation error has been reduced. As such, according to the method of the present embodiment, distance measurement can be carried out with a high level of accuracy.

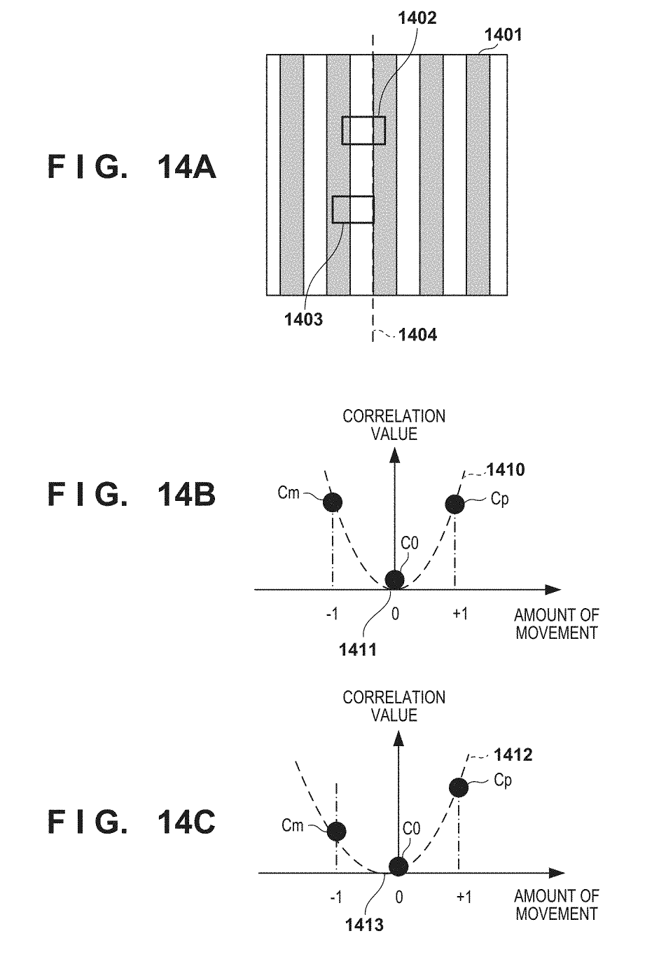

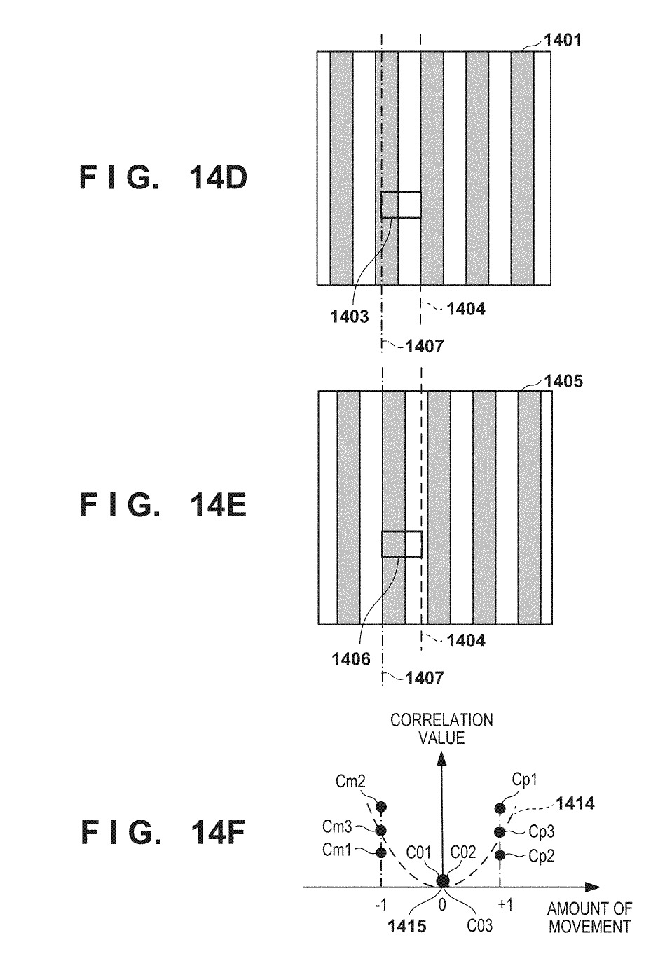

The reason why error arises in the parallax amount calculation in the conventional processing, but the parallax amount calculation error is reduced in the processing according to the present embodiment, will be described next with reference to FIGS. 14A to 14F. The following descriptions assume that the A image and the B image are images having the same contrast, and do not have parallax. FIGS. 14A to 14C are diagrams illustrating a reason why error arises. Note that the reasons why error arises are the same as those described in the first embodiment, and thus the descriptions thereof will be simplified here.

FIG. 14A is a diagram illustrating the positional relationship between an A image 1401, which has a line pattern in which bright regions and dark regions appear in an alternating manner, and base images 1402 and 1403. The base image 1402 has an image edge 1404 (a boundary part), where the bright regions and the dark regions of the A image 1401 switch, within the base image 1402. FIG. 14B illustrates the correlation values calculated by calculating the correlation between the base image 1402 and a referred image set with respect to the base image 1402 while moving the referred image.

Correlation values C0, Cp, and Cm are correlation values obtained when the position of the referred image is moved by 0, +1, and −1 pixels, respectively. In this case, the absolute values of the amounts of movement of the referred image are the same for the correlation values Cp and Cm, which means that the same amount of difference is present between the images due to the image edge 1404 in the line pattern, as described in the first embodiment. As such, the correlation value Cp and the correlation value Cm are the same value. These correlation values are interpolated to find a correlation curve 1410, the amount of movement (parallax amount) at which the correlation value is the highest is calculated to find a parallax amount 1411, and the correct value (a parallax amount of 0) is found.

On the other hand, in the base image 1403, the image edge 1404 overlaps with the right end of the base image 1403. FIG. 14C illustrates the correlation values calculated by calculating the correlation between the base image 1403 and a referred image set with respect to the base image 1403 while moving the referred image. As described in the first embodiment, the correlation values in this case are asymmetrical with respect to the + and − sides of the amounts of movement in the referred image. A parallax amount 1413 found from a correlation curve 1412 obtained by interpolating these correlation values is different from the correct value (a parallax amount of 0), which means that error has arisen. This becomes parallax amount calculation error arising in relation to the brightness distribution of the projected pattern and the positions of the base images.

Next, descriptions will be given regarding the reason why the above-described error is reduced by calculating the first correlation value and the second correlation value from the image pairs obtained by projecting the first patterned light and the second patterned light, which are shifted from each other in the parallax calculation direction, and calculating the parallax amount from those correlation values, as in the present embodiment. FIG. 14D is a diagram illustrating the positions of the A image 1401 obtained by projecting the first patterned light, and a first base image 1403. FIG. 14E is a diagram illustrating the positions of an A image 1405 obtained by projecting the second patterned light, and a second base image 1406. FIG. 14F illustrates the correlation values calculated using the base images.

The first base image 1403 is assumed to be a base image in which the image edge 1404 overlaps with the right end of the base image, in the same manner as described earlier. At this time, first correlation values Cm1, C01, and Cp1 calculated from the first base image 1403 are the same as the correlation values Cm, C0, and Cp indicated in FIG. 14C.

Next, the second patterned light is projected so that the left end of the second base image 1406, which is set to the same position as the first base image 1403, overlaps with an image edge 1407. At this time, the positional relationship between the second base image 1406 and the image edge 1407 is the inverse of the positional relationship between the first base image 1403 and the image edge 1404. For this reason, second correlation values Cm2, C02, and Cp2 obtained using the second base image 1406 are the inverse of the first correlation values Cm1, C01, and Cp1, as indicated in FIG. 14F.

Finding the arithmetic mean of these correlation values for each referred image position (amount of movement) produces correlation value such as third correlation value Cm3, C03, and Cp3. The third correlation values cancel the asymmetry between the + and − sides of the amounts of movement of the referred images, and are therefore symmetrical. In this case, a parallax amount 1415 found from a correlation curve 1414 obtained by interpolating the correlation values is a correct value (a parallax amount of 0), and thus an appropriate parallax amount can be calculated. With the processing according to the present embodiment, the parallax amount calculation error can be reduced on the basis of this principle, and thus highly-accurate distance measurement can be carried out on the basis of the appropriately-calculated parallax amount.

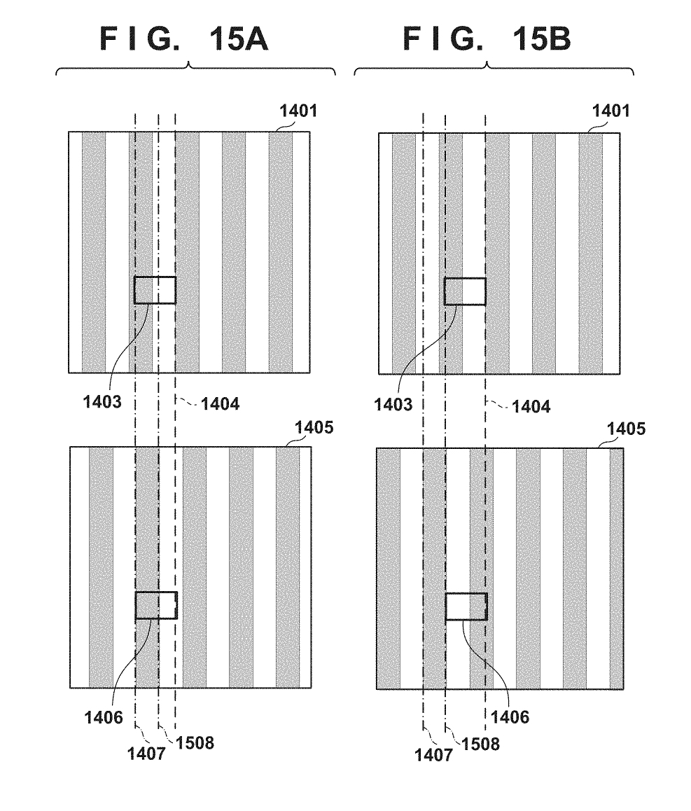

In the present embodiment, varying the positions of the first patterned light and the second patterned light in the parallax calculation direction by an appropriate amount makes it possible to reduce parallax amount calculation error. FIGS. 15A and 15B are diagrams illustrating appropriate positions for the first patterned light and the second patterned light with respect to the base images.

The first base image 1403 and the second base image 1406 are base images set at the same positions in images 1401 and 1405 obtained using the first patterned light and the second patterned light, respectively. The right end of the first base image 1403 overlaps with the image edge 1404 produced by the first patterned light.

Error arising in the correlation values when using the first base image 1403 is thought to be canceled out by the correlation value calculated using the second base image 1406. In this case, the second patterned light may be set so that error arises in the correlation value due to the image edge at the left end of the second base image 1406, so as to cancel out error in the correlation value due to the image edge 1404 at the right end of the first base image 1403. Note that the patterned light setting may be carried out by the calculation processing unit 106, or may be carried out by the control unit 108.

FIG. 15A illustrates a case where the left end of the second base image 1406 overlaps with the image edge 1407 produced by the second patterned light. In this case, error arising in the first correlation value calculated using the first base image 1403 can be canceled out by the second correlation value calculated using the second base image 1406.

FIG. 15B illustrates a case where the left end of the second base image 1406 overlaps with another image edge 1508 produced by the second patterned light. In this case too, error arising in the first correlation value calculated using the first base image 1403 can be canceled out by the second correlation value calculated using the second base image 1406.

In these cases, a difference between the positions of the first patterned light and the second patterned light in the parallax calculation direction (the x-axis direction) can be expressed by the above-described Expression (1a) or Expression (1b). W, P, H, and n in the Expressions are the same parameters as the parameters described in the first embodiment.

With the distance detection method according to the present embodiment, the positions of the first patterned light and the second patterned light are made different from each other, with respect to the parallax calculation direction, by the amount indicated by Expression (1a) or Expression (1b). This makes it possible to most appropriately reduce the parallax amount calculation error, and carry out the distance measurement with a high level of accuracy. Note that the positions of the patterned light can be changed by the control unit 108 controlling and changing the position of pattern forming means, such as a pattern mask, relative to the light source in the projection device 101. The positions of the patterned light may also be changed through another desired known method, such as controlling the spatial light modulator within the projection device 101 or switching among a plurality of pattern forming means, under the control of the control unit 108.

As described above, the projection device 101 according to the present embodiment projects the first patterned light and the second patterned light, which have patterns that are in positions shifted from each other with respect to the parallax calculation direction. The correlation calculation unit 161 calculates the first correlation value on the basis of the first image pair obtained by projecting the first patterned light, and calculates the second correlation value on the basis of the second image pair obtained by projecting the second patterned light. Note that the correlation calculation unit 161 calculates the first correlation value and the second correlation value using the base images set at the same positions in one of the images in the first image pair and one of the images in the second image pair. The parallax calculation unit 162 calculates the parallax amount using the first correlation value and the second correlation value.

Here, the first patterned light and the second patterned light are periodic light in which high-brightness regions and low-brightness regions repeat in an alternating manner in the parallax calculation direction, and have line patterns in which the high-brightness regions and the low-brightness region extend in a second direction perpendicular to the parallax calculation direction. In particular, in the present embodiment, the first patterned light and the second patterned light are patterned light having the same brightness distribution but shifted from each other in the parallax calculation direction.

The projection device 101 projects the first patterned light and the second patterned light, the positions of which have been set according to Expression (1a) or Expression (1b). More specifically, the calculation processing unit 106 sets the positions of the first patterned light and the second patterned light to be shifted from each other in the parallax calculation direction by an amount equivalent to the width of the base image in the parallax calculation direction, or a difference between the stated width and the period of the first patterned light in the captured image. Alternatively, the calculation processing unit 106 sets the positions of the first patterned light and the second patterned light to be shifted from each other in the parallax calculation direction by an amount equivalent to a difference between the width of the base image in the parallax calculation direction and the width of the high-brightness region of the first patterned light in the captured image. As yet another alternative, the calculation processing unit 106 sets the positions of the first patterned light and the second patterned light to be shifted from each other in the parallax calculation direction by an amount obtained by subtracting the period of the first patterned light in the captured image from the stated difference. On the basis of the set positions, the projection device 101 projects the first and second patterned light so that the positions of the pattern of the first patterned light and the pattern of the second patterned light are different with respect to the parallax calculation direction.

With this configuration, the distance detection device according to the present embodiment can reduce the parallax amount calculation error when detecting a distance using an image obtained by capturing projected patterned light. Accordingly, the distance detection device can obtain highly-accurate distance information of the object 102 on the basis of the parallax amount, which has a reduced amount of calculation error.

Note that like the first embodiment, the method of calculating the parallax amount according to the present embodiment is not limited to the method described with reference to S304. For example, the parallax calculation unit 162 may calculate a first parallax amount using the first correlation value, calculate a second parallax amount using the second correlation value, and then find an arithmetic mean of these parallax amounts to calculate a final parallax amount. In this case too, parallax amount calculation error can be reduced, and highly-accurate distance measurement can be carried out. In this case, the correlation calculation unit 161 need not find the third correlation value using the first and second correlation values.

The present embodiment describes an example in which images based on the first patterned light and the second patterned light are obtained in S1201 and S1202, after which the correlation values are calculated using images based on the respective instances of patterned light in S1203 and S1204. However, the timing at which the correlation values are calculated is not limited thereto. For example, the first correlation value may be calculated having obtained an image resulting from the first patterned light, and the second correlation value may then be calculated having obtained an image resulting from the second patterned light. In this case too, the same effects as those described above can be achieved.

Additionally, in one embodiment, an image edge based on the respective instances of patterned light be present near both ends of the base image, regardless of where the base image is set in the captured image. To that end, in another embodiment, the projected pattern is a periodic pattern in which the brightness distribution is repeated in a periodic manner in the x-axis direction, in the same manner as in the first embodiment. If at this time the pattern is a perfectly periodic pattern, there are cases where a region shifted by a single period is mistakenly detected when calculating the parallax amount through correlation calculation. Limiting the range in which to search for the parallax amount (the amount by which the referred images move) to a range smaller than the period of the pattern makes it possible to avoid such erroneous detection.

It is not necessary for the projected pattern to be a pattern in which the same brightness distribution is repeated. The projected pattern may be any pattern in which substantially the same brightness distribution is repeated periodically. For example, the width of bright regions with respect to the parallax calculation direction may differ from line to line. The pattern may be a pattern in which the brightness within bright regions or dark regions varies. Providing a suitable amount of variation in the brightness makes it possible to avoid a situation where a region shifted by one period is erroneously detected, which in turn makes it possible to achieve the above-described effect of reducing parallax amount calculation error.

Like the second embodiment, the distance detection device according to the present embodiment can be applied in an industrial robot device. An example of such a case will be described briefly with reference to FIG. 9. The configuration of the robot device in this case is the same as the configuration of the robot device according to the second embodiment, and thus the same reference signs as in FIG. 9 will be used, and descriptions will be omitted as appropriate.

According to this robot device, the first patterned light and the second patterned light, which have positions shifted from each other with respect to the parallax calculation direction, are projected onto the workpiece 904, and an image pair is captured on the basis of the respective instances of patterned light, as described in the present embodiment. Then, the first correlation value and the second correlation value are calculated for each image pair, and a distance is found, which makes it possible to obtain the distance information of the workpiece 904 with a high level of accuracy. As a result, with the robot device 900, the estimation accuracy of the position and attitude of the workpiece 904 is improved, and the accuracy of the positional control of the robot arm 902 and the robot hand 903 is improved as well, which makes it possible to carry out assembly operations with a higher level of accuracy.

The distance between the distance detection device and the workpiece 904 varies depending on the position of the robot arm 902, the robot hand 903, and so on. If the distance measurement is carried out without changing the projected pattern of the projection device 101, the period of the pattern in the captured image will vary depending on the distance. The optimal positional relationship between the first patterned light and the second patterned light will therefore change, and the effect of reducing parallax amount calculation error may become weaker as a result.

Accordingly, the calculation processing unit 106 may analyze an image obtained by projecting the first patterned light and determine a positional shift amount in the line pattern of the second patterned light on the basis of the analysis result. Specifically, the calculation processing unit 106 analyzes the image obtained by projecting the first patterned light, and calculates/evaluates a period of variation in the pixel values expressing the period of the first patterned light in the obtained image, with respect to the parallax calculation direction. Next, the calculation processing unit 106 determines the positional shift amount of the second patterned light with respect to the parallax calculation direction, on the basis of the width (size) of the first base image in the parallax calculation direction and the period of the pattern.

Additionally, the calculation processing unit 106 may analyze the positional shift amount of the first patterned light and the second patterned light from images obtained by projecting the respective instances of patterned light, and determine the widths of the first and second base images in the parallax calculation direction in accordance with that analysis. Specifically, the calculation processing unit 106 calculates the positional shift amount of the first patterned light and the second patterned light with respect to the parallax calculation direction on the basis of at least one image in image groups obtained by projecting the first patterned light and the second patterned light, respectively. Next, the calculation processing unit 106 determines the widths of the first and second base images on the basis of the positional shift amount of the first patterned light and the second patterned light.

Through this processing, the calculation processing unit 106 can appropriately set the positional shift amount of the first patterned light and the second patterned light, and the sizes of the first and second base images, in accordance with the distance between the distance detection device and the workpiece 904. Note that the positional shift amount, the widths of the base images, and so on can be determined in accordance with the above-described Expression (1a) or Expression (1b). Additionally, the processing carried out by the calculation processing unit 106 may instead be carried out by the control unit 108 or by the control device 905.

Additionally, as the distance between the workpiece 904 and the robot hand 903 decreases, the distance information having a higher in-plane resolution is obtained, and there is demand for the position and attitude of the workpiece 904 to be estimated with a higher level of accuracy. Here, the distance to the workpiece 904 can generally be calculated from the size of the workpiece 904 in the captured image. The obtainment of the distance information of the workpiece 904 by the distance detection device and the control of the robot arm 902 by the control device 905 are carried out sequentially in time series, and thus the distance to the workpiece 904 can also generally be known on the basis of the distance information obtained one cycle previous to that processing.

Accordingly, the calculation processing unit 106 may set the size of the first base image on the basis of the general distance information of the workpiece 904, so that the size of that image decreases as the distance to the workpiece 904 decreases. In this case, the calculation processing unit 106 can determine the positional shift amount of the second patterned light from the period of the first patterned light in the image and the size of the first base image.

Additionally, the calculation processing unit 106 may change the projected pattern so that the period of the projected pattern becomes narrower as the distance decreases. Through such processing, the calculation processing unit 106 can appropriately set the positional shift amount of the first patterned light and the second patterned light in accordance with the distance between the distance detection device and the workpiece 904. Note that the control unit 108, the control device 905, or the like may analyze the images and determine the positional shift amount of the patterned light, instead of the calculation processing unit 106. Additionally, the positions of the patterned light may be controlled by the control unit 108.

By setting the first patterned light, the second patterned light, and the base image appropriately through these methods, the robot device 900 can reduce parallax amount calculation error by the distance detection device, and the distance to the workpiece 904 can therefore be calculated with a high level of accuracy. As a result, with the robot device 900, the estimation accuracy of the position and attitude of the workpiece 904 is improved, and the accuracy of the positional control of the robot arm 902 and the robot hand 903 is improved as well, which makes it possible to carry out assembly operations with a higher level of accuracy.

### Fifth Embodiment

In the distance detection device according to the fourth embodiment, base images are set at the same location in two images obtained by capturing images of the light of two projected patterns shifted from each other in the parallax calculation direction, and a distance is detected by calculating a correlation value with a referred image for each of the base images. In contrast to this, with a distance detection device according to a fifth embodiment, a plurality of instances of patterned light having different wavelength bands are projected, and a distance is detected by obtaining an image pair for each instance of patterned light.

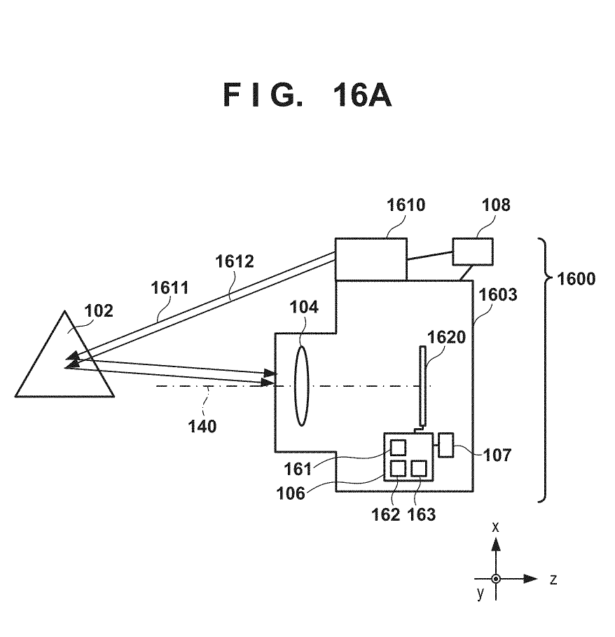

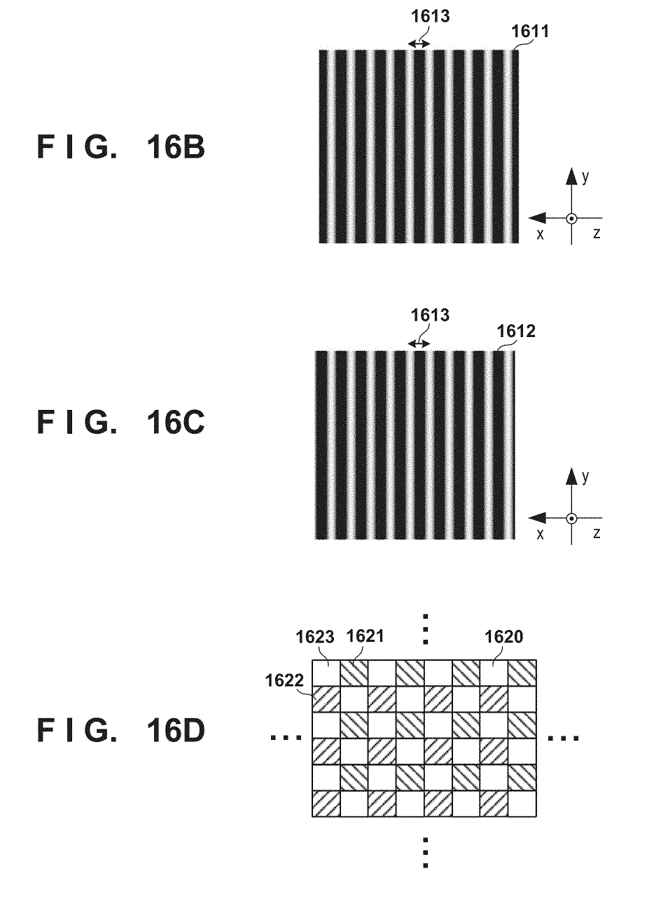

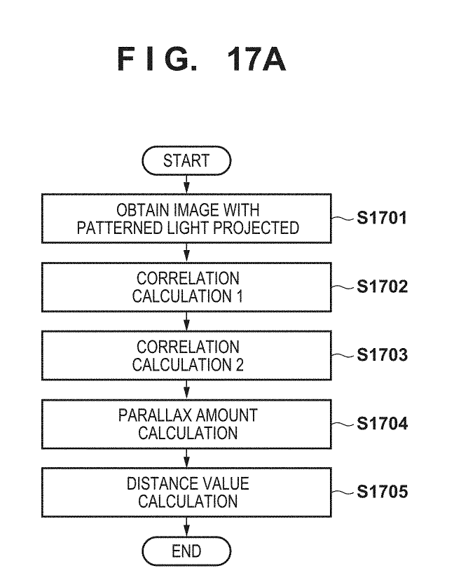

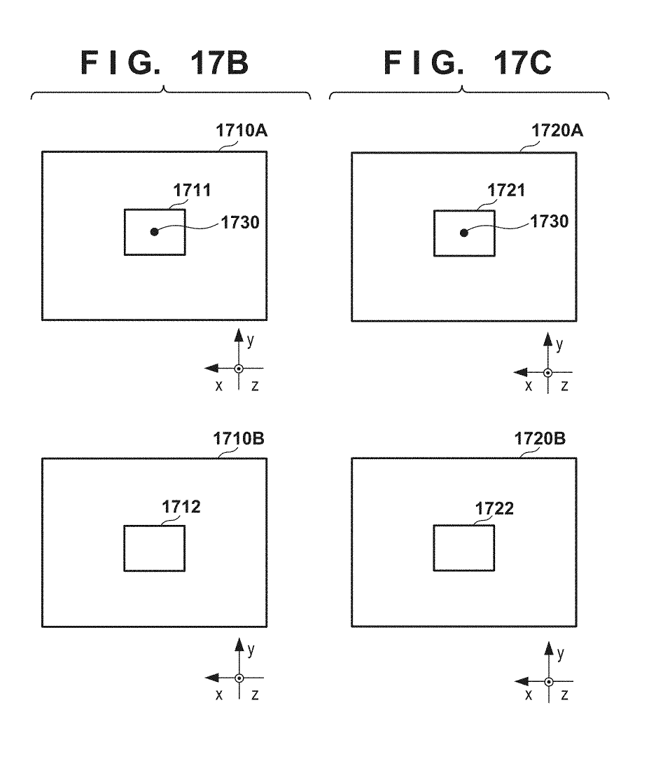

The distance detection device according to the present embodiment will be described hereinafter with reference to FIGS. 16A through 17C. FIG. 16A illustrates an example of the overall configuration of a distance detection device 1600 according to the present embodiment. In the distance detection device 1600 according to the present embodiment, configurations that are the same as those in the distance detection device 100 according to the first embodiment are given the same reference signs, and descriptions will be omitted as appropriate. The distance detection device 1600 according to the present embodiment will be described hereinafter, focusing on the differences from the distance detection device according to the fourth embodiment.

The distance detection device 1600 according to the present embodiment is provided with a projection device 1610 and an image capturing device 1603. The image capturing device 1603 is provided with the image forming optical system 104, an image sensor 1620, the calculation processing unit 106, and the main memory 107. The projection device 1610 and the image capturing device 1603 are connected to a control unit 108, and the control unit 108 controls the synchronization and the like of the projection device 1610 and the image capturing device 1603.

The projection device 1610 is configured to project patterned light 1611 and patterned light 1612. FIGS. 16B and 16C illustrate the patterned light 1611 and 1612, respectively, which are examples of the patterned light projected in the present embodiment. The patterned light 1611, which serves as first patterned light, has a line pattern, and has a period 1613 in which high-brightness regions and low-brightness regions repeat in an alternating manner in the x-axis direction. The patterned light 1612, which serves as second patterned light, has a line pattern having the same periodic brightness distribution in the x-axis direction as the patterned light 1611. The position of the line pattern of the patterned light 1612 is shifted in the x-axis direction with respect to the position of the line pattern of the patterned light 1611.

Here, the patterned light 1611 and the patterned light 1612 according to the present embodiment are light having different wavelength bands. Accordingly, the projection device 1610 is provided with two projection optical systems, each including a light source, and image forming optical system, and pattern forming means, for example. The two projection optical systems include light sources having different wavelength bands and pattern masks having different patterns. Note, however, that a projection optical system that includes the same pattern masks and is configured to be able to change the positions of the pattern masks may be used instead.

FIG. 16D illustrates part of the image sensor 1620. A plurality of pixels 1621, 1622, and 1623 are arranged in the image sensor 1620, and color filters having different transmission wavelength bands are arranged on these pixels. In the present embodiment, the color filter on the pixels 1621 is configured to transmit light in a wavelength band of the patterned light 1611, and the color filter on the pixels 1622 is configured to transmit light in a wavelength band of the patterned light 1612. Using such an image sensor makes it possible for the pixels on which the color filters corresponding to the wavelengths of the respective instances of patterned light are arranged to receive the patterned light in the corresponding wavelengths, which makes it possible to separately obtain image pairs based on the respective instances of patterned light. Note that the arrangement of the plurality of pixels 1621, the plurality of pixels 1622, and the plurality of pixels 1623 in the image sensor 1620 is not limited to the arrangement illustrated in FIG. 16D, and may be changed as desired in accordance with the desired configuration.

The flow of the distance measurement calculation according to the present embodiment will be described next with reference to FIGS. 17A to 17C. FIG. 17A is a flowchart illustrating the distance detection process according to the present embodiment, and FIGS. 17B and 17C are diagrams illustrating the correlation calculation carried out by the correlation calculation unit 161. When the distance detection process according to the present embodiment is started, the process moves to S1701.

In S1701, “obtain image with patterned light projected”, an image is captured using the image capturing device 1603 in a state where the patterned light 1611 and 1612 are projected onto the object 102 by the projection device 1610, and the captured image is stored in the main memory 107. By capturing an image in this state, the image capturing device 1603 can obtain an image pair 1710 using the pixels 1621 and an image pair 1720 using the pixels 1622, and can store those image pairs in the main memory 107. The method for projecting the patterned light is the same as in the first embodiment and the fourth embodiment, and will therefore not be described. Furthermore, the following descriptions assume that the image pair 1710 includes an A image 1710A and a B image 1710B, and that the image pair 1720 includes an A image 1720A and a B image 1720B.

The processing from S1702 to S1705 is carried out by the calculation processing unit 106. Here, FIGS. 17B and 17C are diagrams illustrating the positional relationship between the base image and the referred image set in S1702 and S1703. FIG. 17B illustrates the A image 1710A and the B image 1710B obtained in S1701 using the pixels 1621, and FIG. 17C illustrates the A image 1720A and the B image 1720B obtained using the pixels 1622. Hereinafter, a pixel used for distance calculation, located at the same position in the A image 1710A and the A image 1720A, will be described as a pixel of interest 1730.

In S1702, “correlation calculation 1”, the correlation calculation unit 161 calculates a correlation value using the image pair 1710 obtained in S1701. Specifically, first, the correlation calculation unit 161 extracts a partial region of the A image 1710A, containing the pixel of interest 1730 and the pixels in the periphery thereof, and sets that partial region as a first base image 1711. Next, the correlation calculation unit 161 extracts a region, in the B image 1710B, having the same area as the first base image 1711, and sets that region as a referred image 1712. The correlation calculation unit 161 then calculates the first correlation value using the first base image 1711 and the referred image 1712, in the same manner as in S1203 according to the fourth embodiment.

Note that the method for calculating the correlation value may be the same as that in S302 according to the first embodiment. Additionally, the correlation calculation unit 161 can set the referred image 1712 as an image having the same vertical and horizontal dimensions as the first base image 1711.

Next, in S1703, “correlation calculation 2”, the correlation calculation unit 161 calculates a correlation value using the image pair 1720 obtained in S1701. Specifically, first, the correlation calculation unit 161 extracts a partial region of the A image 1720A, containing the pixel of interest 1730 and the pixels in the periphery thereof, and sets that partial region as a second base image 1721. Next, the correlation calculation unit 161 extracts a region, in the B image 1720B, having the same area as the second base image 1721, and sets that region as a referred image 1722. The correlation calculation unit 161 then calculates the second correlation value using the second base image 1721 and the referred image 1722, in the same manner as in S1204 according to the fourth embodiment. Note that the correlation calculation unit 161 can set the second base image 1721 to the same position as the first base image 1711, in the same manner as in the fourth embodiment.

In S1704, “parallax amount calculation”, the parallax calculation unit 162 calculates a parallax amount using the first correlation value and the second correlation value found in S1703 and S1704, in the same manner as in S304 according to the first embodiment. Specifically, the parallax calculation unit 162 calculates a third correlation value by adding, or finding the arithmetic mean of, the first correlation value and the second correlation value from every amount of movement, and calculates the parallax amount on the basis of the third correlation value. Additionally, in S1705, “distance value calculation”, the distance calculation unit 163 calculates a distance to the object 102 by converting the parallax amount into a defocus amount or an object distance through a known method, in the same manner as in S305 according to the first embodiment.

In this manner, with the distance detection method according to the present embodiment, the projection device 1610 projects the first patterned light and the second patterned light, which have line patterns at positions shifted in the parallax calculation direction, and which have different wavelength bands. Additionally, the image capturing device 1603 separately obtains the image pair based on the first patterned light and the image pair based on the second patterned light. The correlation calculation unit 161 sets the first base image 1711 and the second base image 1721 for the respective image pairs. Then, the correlation calculation unit 161 calculates the first correlation value with the referred image 1712 set corresponding to the first base image 1711, and the second correlation value with the referred image 1722 set corresponding to the second base image 1721. The parallax calculation unit 162 calculates the parallax amount using the correlation values. According to this process, the first correlation value and the second correlation value are calculated from the respective image pairs, and the parallax amount is calculated from the correlation values. This makes it possible to reduce distance measurement error arising in relation to the brightness distribution of the projected patterns and the positions of the base images, which in turn makes it possible to carry out highly-accurate distance measurement.

In particular, in the present embodiment, the first patterned light and the second patterned light, which have different wavelength bands, are projected at the same time, and image pairs based on the respective instances of patterned light are obtained by the image sensor 1620. Accordingly, the distance can be measured through a single instance of pattern projection, and thus the measurement can be taken quickly.

Note that, in one embodiment, the wavelength bands of the first patterned light and the second patterned light are to be distant from each other. For example, the first patterned light can be set to a wavelength band corresponding to blue light or ultraviolet light, and the second patterned light can be set to a wavelength band corresponding to red light or infrared light. Separating the wavelength bands of the respective instances of patterned light makes it easy to separately obtain image pairs produced by the respective instances of patterned light, with a generally-available image sensor.

Additionally, in the present embodiment, an object image that does not have the pattern of the patterned light can be obtained by arranging a color filter, which does not transmit light in the wavelength bands of the patterned light 1611 and the patterned light 1612, on the pixels 1623. Using session image makes it possible to specify the location, on the object 102, where the distance information found through the above-described method was measured. The image information and the distance information can be used to detect the position, attitude, and so on of the object 102. The information can also be used to determine what type of object the captured object 102 is, from among a plurality of types of objects. Note that the processes for detecting the position, attitude, and so on of the object 102 using the image information, the distance information, and so on may be carried out by the calculation processing unit 106, the control unit 108, or the like.

### Sixth Embodiment

In the first embodiment, base images are set at different locations, in the parallax calculation direction, in an image obtained by capturing light of a single projected pattern, and a distance is detected by calculating a correlation value with a referred image for each of the base images. In contrast to this, with the distance detection device according to a sixth embodiment, a base image is set in an image obtained by capturing the light of a projected pattern including two sub patterns shifted from each other in the parallax calculation direction, and the distance is detected by calculating a correlation value of a referred image with respect to the base image.

The distance detection device according to the present embodiment will be described hereinafter with reference to FIGS. 18 through 22B. The configuration of the distance detection device according to the present embodiment is the same as the configuration of the distance detection device 100 according to the first embodiment, and thus the same reference signs as in the first embodiment will be assigned, and descriptions will be omitted. The following descriptions will focus on the difference between the distance detection device according to the present embodiment and the distance detection device 100 according to the first embodiment.

FIG. 18 illustrates and example of the patterned light projected in the present embodiment. Patterned light 1800 is constituted by patterned light 1801 (first sub patterned light) and patterned light 1802 (second sub patterned light). The patterned light 1801 and 1802 have the same brightness distribution in the x-axis direction (the first direction), and are shifted from each other in the x-axis direction. The patterned light 1801 and 1802 are located at different positions in the y-axis direction (the second direction), and in the present embodiment, the patterned light 1801 and 1802 are positioned in an alternating manner in the y-axis direction. The brightness distribution of each instance of patterned light in the x-axis direction has a period 1803, in which high-brightness regions and low-brightness regions repeat in an alternating manner. The patterned light 1801 and 1802 have the same length 1804 in the y-axis direction.

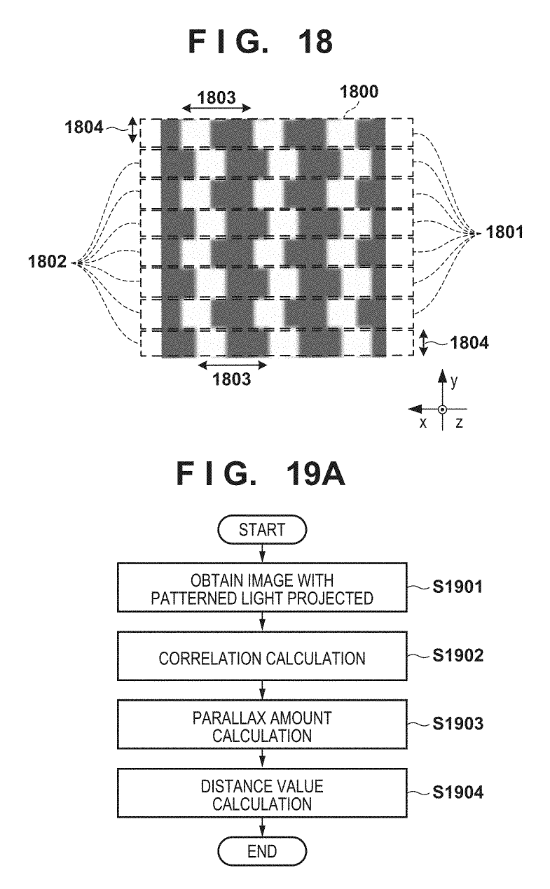

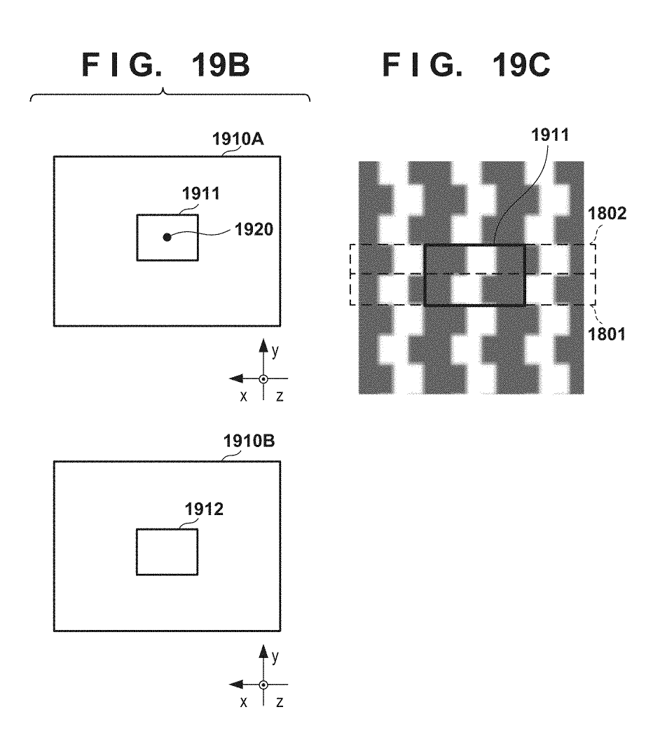

The flow of the distance measurement calculation according to the present embodiment will be described next with reference to FIGS. 19A to 19C. FIG. 19A is a flowchart illustrating the distance detection process according to the present embodiment, and FIGS. 19B and 19C are diagrams illustrating the correlation calculation carried out by the correlation calculation unit 161. When the distance detection process according to the present embodiment is started, the process moves to S1901.

In S1901, “obtain image with patterned light projected”, an image is captured using the image capturing device 103 in a state where the patterned light 1800 is projected onto the object 102 by the projection device 101, and the captured image is stored in the main memory 107. Note that the method for projecting the patterned light is the same as in the first embodiment, and will therefore not be described.

The processing from S1902 to S1904 is carried out by the calculation processing unit 106. Here, FIGS. 19B and 19C are diagrams illustrating the positional relationship between the base image and the referred image set in S1902. FIG. 19B illustrates an A image 1910A and a B image 1910B obtained in S1901. Hereinafter, a pixel used for distance calculation, located in the A image 1910A, will be described as a pixel of interest 1920.

In S1902, “correlation calculation”, the correlation calculation unit 161 calculates a first correlation value using the image pair obtained in S1901. Specifically, the correlation calculation unit 161 extracts a partial region of the A image 1910A, containing the pixel of interest 1920 for calculating the distance and the pixels in the periphery thereof, and sets that partial region as a base image 1911. FIG. 19C is a diagram illustrating the region of the base image. The correlation calculation unit 161 sets the base image 1911 so as to include the regions where the patterned light 1801 and the patterned light 1802 are projected.

Next, the correlation calculation unit 161 extracts a region, in the B image 1910B, having the same area (image size) as the base image 1911, and sets that region as a referred image 1912. The correlation calculation unit 161 then moves the position in the B image 1910B from where the referred image 1912 is extracted in the same x-axis direction as the pupil division direction, and calculates a correlation value between the referred image 1912 and the base image 1911 every given amount of movement (at each position). In this manner, the correlation calculation unit 161 calculates the correlation value from a data string of correlation values corresponding to each amount of movement.

Note that the method for calculating the correlation value may be the same as that in S302 according to the first embodiment. Additionally, the correlation calculation unit 161 can set the referred image 1912 as an image having the same vertical and horizontal dimensions as the base image 1911.

Next, in S1903, “parallax amount calculation”, the parallax calculation unit 162 calculates a parallax amount using the correlation value found in S1902, through a desired known method. For example, the parallax amount can be calculated by extracting a data string containing the amount of movement where the highest of the correlation values is obtained and correlation values corresponding to similar amounts of movement, and then estimating, with sub pixel accuracy, the amount of movement at which the correlation is the highest through a desired known interpolation method.

Additionally, in S1904, “distance value calculation”, the distance calculation unit 163 calculates a distance to the object 102 by converting the parallax amount into a defocus amount or an object distance through a known method, in the same manner as in S305 according to the first embodiment.

With the distance detection method according to the present embodiment, the base image 1911 is set so as to include the regions where the patterned light 1801 and the patterned light 1802, which are shifted from each other in the pupil division direction (the parallax calculation direction), are projected. By then calculating the correlation value between the base image 1911 and the referred image 1912, and calculating the parallax amount from the correlation value, distance measurement error arising in relation to the brightness distribution of the projected patterns and the position of the base image can be reduced, which makes it possible to measure the distance with a high level of accuracy.

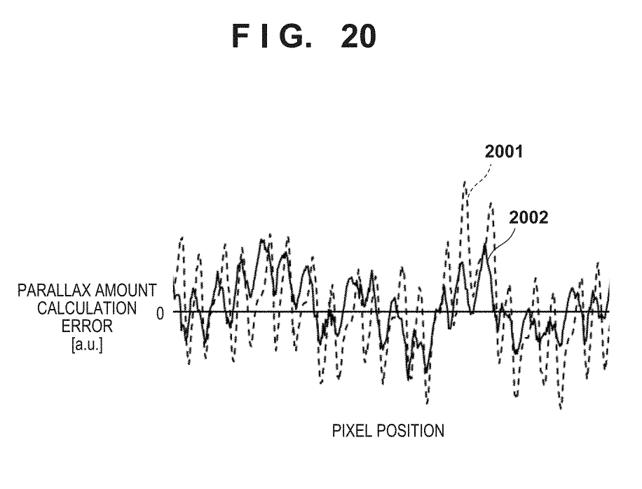

An example of a result of the processing in the distance detection method according to the present embodiment will be described next with reference to FIG. 20. FIG. 20 is a graph illustrating a result of calculating the parallax amount at each of positions on a flat plate, when the projection device 101 is used to project patterned light onto the flat plate, which is arranged parallel to the image capturing device 103 at a known distance, and that pattern is captured by the image capturing device 103. In FIG. 20, the horizontal axis represents the amount of movement (pixel position), and the vertical axis represents parallax amount calculation error. In FIG. 20, calculation error 2001 in the parallax amount calculated by projecting a line pattern in which bright parts and dark parts extend uniformly in the y-axis direction is represented by the broken line as a conventional process, whereas calculation error 2002 in the parallax amount calculated by projecting a pattern as described in the present embodiment is represented by the solid line. It can be seen that compared to the conventional method, the method according to the present embodiment brings the amount of error close to 0, i.e., the parallax amount calculation error has been reduced. As such, according to the processing of the present embodiment, distance measurement can be carried out with a high level of accuracy.

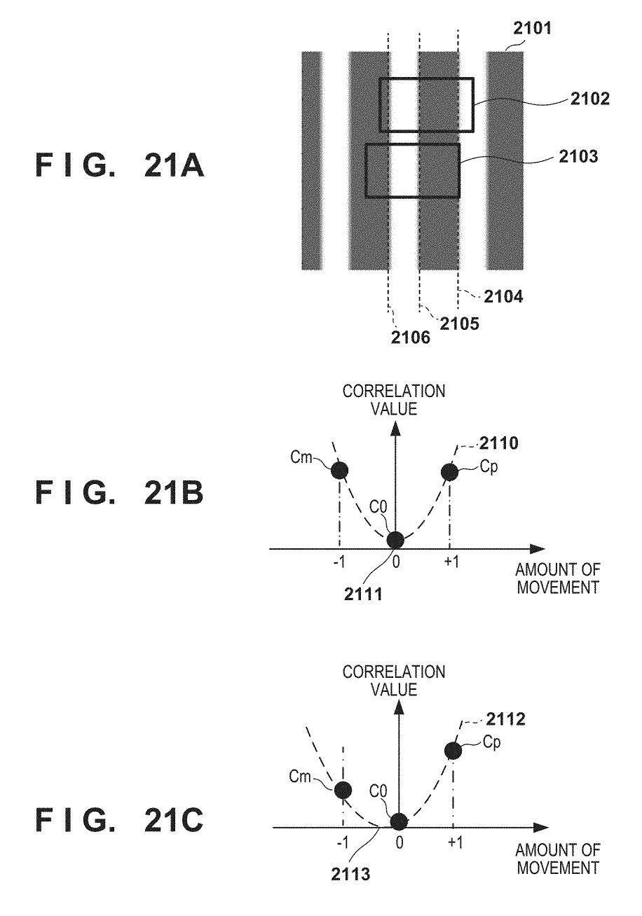

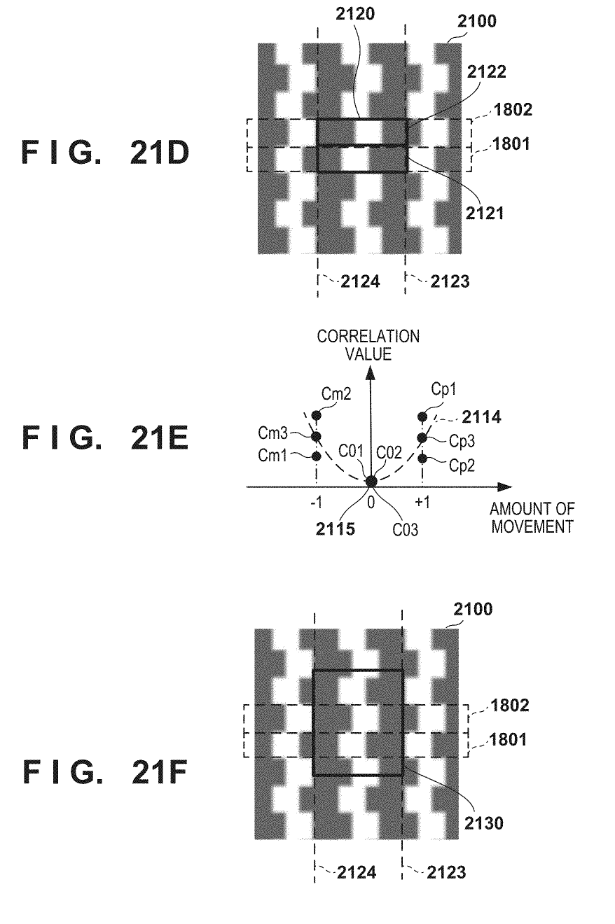

The reason why error arises in the parallax amount calculation in the conventional processing, but the parallax amount calculation error is reduced in the processing according to the present embodiment, will be described next with reference to FIGS. 21A to 21F. The following descriptions assume that the A image and the B image are images having the same contrast, and do not have parallax. FIGS. 21A to 21C are diagrams illustrating a reason why error arises when calculating the parallax amount by projecting a line pattern using the conventional method. Note that the reasons why error arises are the same as those described in the first embodiment, and thus the descriptions thereof will be simplified here.

FIG. 21A is a diagram illustrating the positional relationship between an A image 2101, which has a line pattern in which bright regions and dark regions appear in an alternating manner, and base images 2102 and 2103. The base image 2102 has image edges 2104, 2105, and 2106 (boundary parts), where the bright regions and the dark regions of the A image 2101 switch, within the base image 2102. FIG. 21B illustrates the correlation values calculated by calculating the correlation between the base image 2102 and a referred image set with respect to the base image 2102 while moving the referred image.

Correlation values C0, Cp, and Cm are correlation values obtained when the position of the referred image is moved by 0, +1, and −1 pixels, respectively. In this case, the absolute values of the amounts of movement of the referred image are the same for the correlation values Cp and Cm, which means that the same amount of difference is present between the images due to the image edges 2104, 2105, and 2106 in the line pattern, as described in the first embodiment. As such, the correlation value Cp and the correlation value Cm are the same value. These correlation values are interpolated to find a correlation curve 2110, the amount of movement (parallax amount) at which the correlation value is the highest is calculated to find a parallax amount 2111, and the correct value (a parallax amount of 0) is found.

On the other hand, in the base image 2103, an image edge 2104 overlaps with the right end of the base image 2103. FIG. 21C illustrates the correlation values calculated by calculating the correlation between the base image 2103 and a referred image set with respect to the base image 2103 while moving the referred image. In this case, when the amount of movement is +1 pixel, the correlation value Cp is higher than the correlation value C0, as is the case with the base image 2102. However, when the amount of movement is −1 pixel, a difference arises between the base image and the referred image due to the image edges 2105 and 2106 only, and thus the correlation value Cm is higher than the correlation value C0 by only an extremely small amount. For this reason, the correlation values are asymmetrical with respect to the + and − sides of the amounts of movement in the referred image. A parallax amount 2113 found from a correlation curve 2112 obtained by interpolating these correlation values is different from the correct value (a parallax amount of 0), which means that error has arisen. This becomes parallax amount calculation error arising in relation to the brightness distribution of the projected pattern and the positions of the base images.

Next, descriptions will be given regarding the reason why the above-described error is reduced by projecting the patterned light 1800 containing the patterned light 1801 and 1802, which are shifted from each other in the parallax calculation direction, capturing an image of the projected patterned light 1800, and carrying out distance measurement calculations using a base image including the patterned light 1801 and 1802, as in the present embodiment. FIG. 21D is a diagram illustrating an A image 2100 and a base image 2120 obtained by projecting the patterned light 1800, according to the present embodiment. FIG. 21E is a diagram illustrating correlation values calculated from a first partial image 2121 and a second partial image 2122 obtained by dividing the base image 2120, in order to simplify the descriptions of the principle of this process.

A partial image in which an image edge 2123 produced by the patterned light 1801 overlaps with a right end of the partial image is assumed as the first partial image 2121. At this time, first correlation values Cm1, C01, and Cp1 calculated from the first partial image 2121 are the same as the correlation values Cm, C0, and Cp indicated in FIG. 21C.

Next, a partial image that is different from the first partial image 2121, in which a left end of the partial image overlaps with an image edge 2124 produced by the patterned light 1802, is set as the second partial image 2122. At this time, the positional relationship between the second partial image 2122 and the image edge 2124 is the inverse of the positional relationship between the first partial image 2121 and the image edge 2123. For this reason, second correlation values Cm2, C02, and Cp2 obtained using the second partial image 2122 are the inverse of the first correlation values Cm1, C01, and Cp1, as indicated in FIG. 21E.

Finding the arithmetic mean of these correlation values for each referred image position (amount of movement) produces correlation value such as third correlation value Cm3, C03, and Cp3. The third correlation values cancel the asymmetry between the + and − sides of the amounts of movement of the referred images, and are therefore symmetrical. In this case, a parallax amount 2115 found from a correlation curve 2114 obtained by interpolating the correlation values is a correct value (a parallax amount of 0), and thus an appropriate parallax amount can be calculated. With the processing according to the present embodiment, the parallax amount calculation error can be reduced on the basis of this principle, and thus highly-accurate distance measurement can be carried out on the basis of the appropriately-calculated parallax amount.

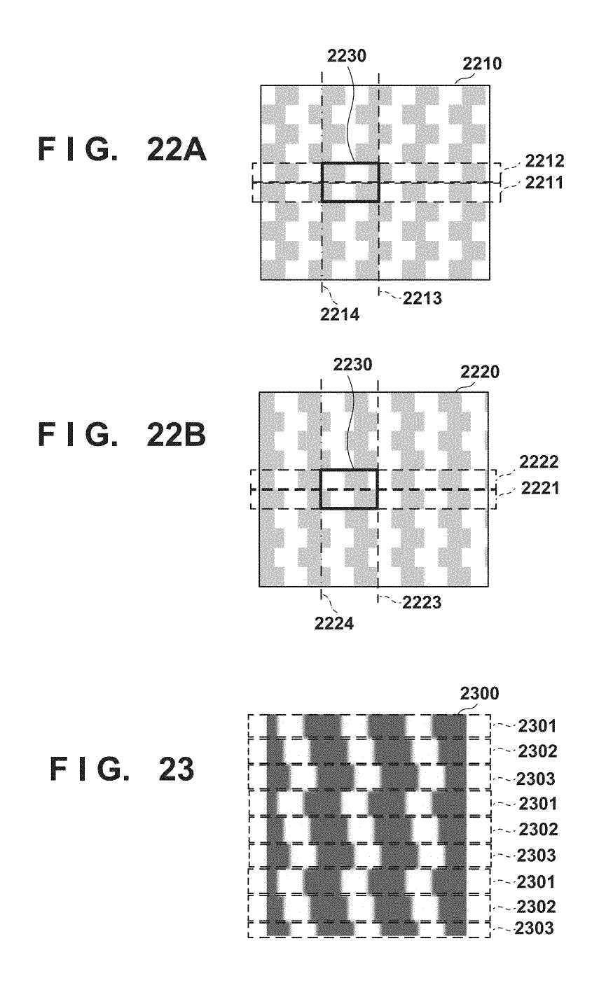

In the present embodiment, varying the patterned light 1801 and the patterned light 1802 in the x-axis direction (the parallax calculation direction) by an appropriate amount makes it possible to reduce parallax amount calculation error. FIGS. 22A and 22B are diagrams illustrating appropriate positions for the first patterned light and the second patterned light included in the projected patterned light, and for the base image.

A base image 2230 is a base image set for images 2210 and 2220, which have been obtained using different patterned light including the first patterned light and the second patterned light. In FIGS. 22A and 22B, the right end of the base image 2230 overlaps with an image edge produced by the first patterned light.

Here, a case where error in a correlation value based on the image edge of the first patterned light is canceled out using the second patterned light will be considered. In this case, for example, the second patterned light may be set so that error arises in the correlation value due to the image edge of the second patterned light at the left end of the base image, in order to cancel out error in the correlation value due to the image edge of the first patterned light at the right end of the base image. Note that when canceling out error in the correlation value due to the image edge of the first patterned light at the left end of the base image, the second patterned light may be set so that error arises in the correlation value due to the image edge of the second patterned light at the right end of the base image. Note that the patterned light setting may be carried out by the calculation processing unit 106, or may be carried out by the control unit 108.

FIG. 22A illustrates the image 2210, which is obtained by projecting patterned light including first patterned light 2211 and second patterned light 2212. In the image 2210, the right end of the base image 2230 overlaps with an image edge 2213 of the first patterned light 2211, and the left end of the base image overlaps with an image edge 2214 of the second patterned light 2212. In this case, error in the first correlation value arising on the basis of the image edge 2213 of the first patterned light 2211 can be canceled out by using the second correlation value calculated on the basis of the image edge 2214 of the second patterned light 2212.

FIG. 22B illustrates the image 2220, which is obtained by projecting patterned light including first patterned light 2221 and second patterned light 2222. In the image 2220, the right end of the base image 2230 overlaps with an image edge 2223 of the first patterned light 2221, and the left end of the base image 2230 overlaps with an image edge 2224 of the second patterned light 2222. In this case, error in the first correlation value arising on the basis of the image edge 2223 of the first patterned light 2221 can be canceled out by using the second correlation value calculated on the basis of the image edge 2224 of the second patterned light 2222.

In these cases, a difference between the positions of the first patterned light and the second patterned light in the parallax calculation direction (the x-axis direction) can be expressed by the above-described Expression (1a) or Expression (1b). W, P, H, and n in the Expressions are the same parameters as the parameters described in the first embodiment.

With the distance detection method according to the present embodiment, the positions of the first patterned light and the second patterned light are made different from each other, with respect to the parallax calculation direction, by the amount indicated by Expression (1a) or Expression (1b). This makes it possible to most appropriately reduce the parallax amount calculation error, and carry out the distance measurement with a high level of accuracy. Note that the positions of the patterned light can be changed by the control unit 108 controlling and changing the position of pattern forming means, such as a pattern mask for forming each instance of sub patterned light, relative to the light source in the projection device 101. The positions of the patterned light may also be changed through another desired known method, such as controlling the spatial light modulator within the projection device 101 or switching among a plurality of pattern forming means, under the control of the control unit 108.

Note that the lengths of the first patterned light and the second patterned light in a direction perpendicular to the parallax calculation direction (the y-axis direction) are set to be shorter than the length of the base image in the same direction. This ensures that the projection regions of the patterned light are included in the base image, and using such a base image makes it possible to reduce parallax amount calculation error. In particular, the lengths of the first patterned light and the second patterned light in the direction perpendicular to the parallax calculation direction can be set to lengths equivalent to an even-numbered fraction of 1 with respect to the length of the base image in the same direction. In this case, the projected regions of the patterned light are present in the base image in equal amounts, which makes it possible to achieve the effect of reducing parallax amount calculation error to the greatest extent possible.

Meanwhile, the first patterned light and the second patterned light can be projected in an alternating manner without providing gaps in the y-axis direction. In this case, there is an increase in the number of regions in the base image where the brightness changes due to the first patterned light and the second patterned light, which makes it possible to appropriately reduce parallax amount calculation error, and calculate the parallax amount with a high level of accuracy.

Although the present embodiment describes the patterned light as two instances of sub patterned light, the number of instances of sub patterned light included in the patterned light is not limited thereto. For example, as illustrated in FIG. 23, patterned light 2300 may contain patterned light 2301 (the first sub patterned light), patterned light 2302 (the second sub patterned light), and patterned light 2303 (third sub patterned light).

The patterned light 2301, 2302, and 2303 have the same brightness distribution with respect to the x-axis direction (the parallax calculation direction; the first direction), and are shifted relative to each other in the x-axis direction. Additionally, the patterned light 2301, 2302, and 2303 are projected at different positions with respect to the y-axis direction (the second direction), and more specifically, are projected in a repeating order. The brightness distribution of each instance of the patterned light 2301, 2302, and 2303 in the x-axis direction has the same period, in which high-brightness regions and low-brightness regions repeat in an alternating manner.

Even with such patterned light, by having an image edge produced by any of the patterned light falling on both ends of the base image, the above-described effect of reducing parallax amount calculation error can be achieved. Note that the same effect can be achieved even when the number of instances of sub patterned light is greater than or equal to 3.

As described above, with the distance detection device according to the present embodiment, the projected patterned light contains the first sub patterned light and the second sub patterned light. The first sub patterned light and the second sub patterned light are patterned light shifted from each other in the parallax calculation direction (the first direction), and in the second direction perpendicular to the first direction. Additionally, the first sub patterned light and the second sub patterned light are periodic light in which high-brightness regions and low-brightness regions repeat in an alternating manner in the first direction, and in the present embodiment, are instances of light in which patterned light having the same brightness distribution are shifted from each other in the first and second directions. The base image includes an image of a region in which the first sub patterned light and the second sub patterned light are projected.

The projection device 101 projects the first sub patterned light and the second sub patterned light, the positions of which have been set according to Expression (1a) or Expression (1b). Specifically, the calculation processing unit 106 sets the positions of the first sub patterned light and the second sub patterned light so as to be shifted in the parallax calculation direction by an amount equivalent to the width of the base image in the first direction, or a difference between the stated width and the period, in the first direction, of the first sub patterned light in the captured image. Alternatively, the calculation processing unit 106 sets the positions of the first sub patterned light and the second sub patterned light so as to be shifted in the parallax calculation direction by an amount equivalent to a difference between the width of the base image in the first direction and a width, in the first direction, of the high-brightness regions of the first sub patterned light in the captured image. As yet another alternative, the calculation processing unit 106 sets the positions of the first sub patterned light and the second sub patterned light so as to be shifted in the parallax calculation direction by an amount obtained by subtracting the period, in the first direction, of the first sub patterned light in the captured image from the stated difference. On the basis of the set positions, the projection device 101 projects the patterned light so that the first sub patterned light and the second sub patterned light have different positions with respect to the first direction.

With this configuration, the distance detection device according to the present embodiment can reduce the parallax amount calculation error when detecting a distance using an image obtained by capturing projected patterned light. Accordingly, the distance detection device can obtain highly-accurate distance information of the object 102 on the basis of the parallax amount, which has a reduced amount of calculation error.

In the present embodiment, the base image is divided, correlation values are calculated for each of the resulting partial images, and an arithmetic mean is found for the correlation values, as the method of calculating the correlation value. However, the method for calculating the correlation value is not limited thereto. For example, a correlation value may be calculated for each of rows in the base image, and the arithmetic mean may be calculated for the correlation values from those rows. Alternatively, a correlation value may be calculated using the entire region of the base image. Note that the calculation for finding the correlation values of the partial images, the rows, and the like is not limited to an arithmetic mean, and may be adding instead.

Additionally, the present embodiment describes a case where the base image 2120 is set so that the projection region of the patterned light 1801 is present in the upper half of the image and the projection region of the patterned light 1802 is present in the lower half of the image. However, the method for setting the base image is not limited thereto. FIG. 21F illustrates another example of the base image setting. For example, the base image may be set so that the projection regions of the patterned light 1801 and 1802 are present in a plurality of regions within the base image, with respect to the y direction, as indicated by a base image 2130 in FIG. 21F. In other words, the length of the base image in the y direction may be set to a length that is an integral multiple of the period of the patterned light 1801 and 1802 with respect to the y direction.

Even if the correlation values in the parallax amount are calculated through this method, parallax amount calculation error can be reduced, which makes it possible to carry out highly-accurate distance measurement on the basis of the appropriately-calculated parallax amount.

Note that, in one embodiment, an image edge based on the respective instances of patterned light is present near both ends of the base image, regardless of where the base image is set in the captured image. To that end, the projected pattern is a periodic pattern in which the brightness distribution is repeated in a periodic manner in the x-axis direction. If at this time the pattern is a perfectly periodic pattern, there are cases where a region shifted by a single period is mistakenly detected when calculating the parallax amount through correlation calculation. Limiting the range in which to search for the parallax amount (the displacement amount by which the referred images move) to a range smaller than the period of the pattern makes it possible to avoid such erroneous detection.

It is not necessary for the projected pattern to be a pattern in which the same brightness distribution is repeated. The projected pattern may be any pattern in which substantially the same brightness distribution is repeated periodically. For example, the width of bright regions with respect to the parallax calculation direction may differ from line to line. The pattern may be a pattern in which the brightness within bright regions or dark regions varies. Providing a suitable amount of variation in the brightness makes it possible to avoid a situation where a region shifted by one period is erroneously detected, which in turn makes it possible to achieve the above-described effect of reducing parallax amount calculation error.

Like the second embodiment, the distance detection device according to the present embodiment can be applied in an industrial robot device. An example of such a case will be described briefly with reference to FIG. 9. The configuration of the robot device in this case is the same as the configuration of the robot device according to the second embodiment, and thus the same reference signs as in FIG. 9 will be used, and descriptions will be omitted as appropriate.

According to this robot device, the patterned light 1800, which includes the first patterned light 1801 and the second patterned light 1802, is projected onto the workpiece 904, and an image pair is captured on the basis of the patterned light 1800, as described in the present embodiment. Then, by calculating the correlation value using the base image including the projection regions of the patterned light 1801 and 1802, and finding a distance, the distance information of the workpiece 904 can be obtained with a higher level of accuracy. As a result, with the robot device 900, the estimation accuracy of the position and attitude of the workpiece 904 is improved, and the accuracy of the positional control of the robot arm 902 and the robot hand 903 is improved as well, which makes it possible to carry out assembly operations with a higher level of accuracy.

The distance between the distance detection device and the workpiece 904 varies depending on the position of the robot arm 902, the robot hand 903, and so on. If the distance measurement is carried out without changing the projected pattern of the projection device 101, the size of the pattern in the captured image will vary depending on the distance. Thus in this case, the positions of the image edges produced by the patterned light 1801 and 1802, the ratio of the patterned light 1801 and 1802 present in the base image, and so on may change, and the effect of reducing parallax amount detection error may become weaker as a result.

Accordingly, the calculation processing unit 106 can analyze an image obtained by capturing the patterned light 1800, and can calculate/evaluate a positional shift amount of the patterned light 1801 and 1802 with respect to the x-axis direction, an interval of the period in the x-axis direction, or the length in the y-axis direction. Next, the calculation processing unit 106 can determine the size of the base image in accordance with these sizes.

Additionally, the calculation processing unit 106 may determine the positional shift amount of the patterned light 1801 and 1802 with respect to the x-axis direction, the interval of the period, or the length in the y-axis direction on the basis of these sizes calculated from the captured image and the size of the base image. In this case, the distance measurement can be carried out by the control unit 108 controlling the projection device 101 so that the patterned light is projected having been corrected on the basis of the parameters determined by the calculation processing unit 106.

According to such processing, the distance measurement can be carried out using the optimal base image and projected patterned light, in accordance with the distance between the distance detection device and the workpiece 904, which makes it possible to carry out highly-accurate distance measurement. Note that the processing carried out by the calculation processing unit 106 may instead be carried out by the control unit 108 or by the control device 905.

Additionally, as the distance between the workpiece 904 and the robot hand 903 decreases, the distance information having a higher in-plane resolution is obtained, and there is demand for the position and attitude of the workpiece 904 to be estimated with a higher level of accuracy. Here, the distance to the workpiece 904 can generally be calculated from the size of the workpiece 904 in the captured image. The obtainment of the distance information of the workpiece 904 by the distance detection device and the control of the robot arm 902 by the control device 905 are carried out sequentially in time series, and thus the distance to the workpiece 904 can also generally be known on the basis of the distance information obtained one cycle previous to that processing.

Accordingly, the calculation processing unit 106 may set the positional shift amount of the patterned light 1801 and 1802 with respect to the x-axis direction, the interval of the period, or the length in the y-axis direction to be lower on the basis of the general distance information of the workpiece 904. Alternatively, the calculation processing unit 106 may set the size of the base image in the x-axis direction and the y-axis direction to be smaller as the distance decreases, on the basis of the interval of the periods of the patterned light 1801 and 1802. According to such processing, the distance measurement can be carried out using the optimal base image and projected patterned light, in accordance with the distance between the distance detection device and the workpiece 904, which makes it possible to carry out highly-accurate distance measurement. Note that the processing carried out by the calculation processing unit 106 may instead be carried out by the control unit 108 or by the control device 905.

According to these methods, the patterned light and the base image can be set appropriately, the robot device 900 can reduce parallax amount calculation error by the distance detection device, and the distance to the workpiece 904 can be calculated with a high level of accuracy. As a result, with the robot device 900, the estimation accuracy of the position and attitude of the workpiece 904 is improved, and the accuracy of the positional control of the robot arm 902 and the robot hand 903 is improved as well, which makes it possible to carry out assembly operations with a higher level of accuracy.

### Seventh Embodiment

In the first embodiment, a first base image and a second base image are set at different positions, with respect to the parallax calculation direction, in the captured image obtained by projecting patterned light. Then, correlation values are calculated between the base images and a referred image, and the parallax amount is calculated from the correlation values. Additionally, in the fourth embodiment, first patterned light and second patterned light, which are shifted from each other with respect to the parallax calculation direction, are projected, and image pairs based on the respective instances of patterned light are obtained. A first correlation value and a second correlation value are then calculated from the respective image pairs, and the parallax amount is calculated from the correlation values. Furthermore, in the sixth embodiment, patterned light including a plurality of instances of sub patterned light, which are shifted from each other with respect to the parallax calculation direction, is projected, and a base image is set so as to include the regions, in the captured image, where the instances of sub patterned light are projected. Correlation values are then calculated using the base image, and the parallax amount is calculated.

Here, the method according to the first embodiment will be called a “first method”, the method according to the sixth embodiment will be called a “second method”, and the method according to the fourth embodiment will be called a “third method”. In the first method and the second method, the distance can be measured through a single instance of pattern projection, and thus the distance measurement can be taken quickly. However, in the third method, the base image is set to a narrow region including the pixel of interest, and the distance measurement is carried out by adjusting the positions of the plurality of instances of patterned light. This makes it possible to avoid a situation where the distance information of an object in the periphery of the pixel of interest is intermixed, which makes it possible to measure the distance of the pixel of interest with a high level of accuracy.

Accordingly, the seventh embodiment describes a case where the first to third methods are used alternately in accordance with distance measurement conditions. Note that the configurations of the distance detection device and the robot device according to the present embodiment are the same as the configuration of the distance detection device according to the first embodiment and the configuration of the robot device according to the second embodiment. As such, the same reference signs as those in FIGS. 1A, 1B, and 9 will be used, and descriptions will be omitted as appropriate.

For example, in the robot device 900 described in the second embodiment, the robot hand 903 is to be quickly moved near the workpiece 904 when the distance between the robot hand 903 and the workpiece 904 is great. In such a case, the first method or the second method is to be used to measure the distance quickly.

On the other hand, the robot hand 903 accurately positioned with respect to the workpiece 904 when the distance between the robot hand 903 and the workpiece 904 is small. In such a case, the third method is to be used to measure the position of the workpiece with a high level of accuracy.

Accordingly, with the robot device according to the present embodiment, the calculation processing unit 106 carries out the distance measurement using the first method described in the first embodiment or the second method described in the sixth embodiment when the distance between the distance detection device and the workpiece 904 is greater than a prescribed distance. Additionally, the calculation processing unit 106 carries out the distance measurement using the third method described in the fourth embodiment when the distance between the distance detection device and the workpiece 904 is less than or equal to the prescribed distance (is shorter than the prescribed distance).

Here, the distance to the workpiece 904 can generally be calculated from the size of the workpiece 904 in the captured image. The obtainment of the distance information of the workpiece 904 by the distance detection device and the control of the robot arm 902 by the control device 905 are carried out sequentially in time series, and thus the distance to the workpiece 904 can also generally be known on the basis of the distance information obtained one cycle previous to that processing. Accordingly, the calculation processing unit 106 may switch between the methods used to detect the distance between the distance detection device and the workpiece 904 (a second distance) on the basis of this overall distance to the workpiece 904 (a first distance). In the case where the method used to measure the distance is switched on the basis of successively-detected distances, when the distance to the workpiece 904 is detected for the first time, the calculation processing unit 106 may detect the distance to the workpiece 904 using a method, among the first to third methods, that has been set in advance.

With the distance detection device according to the present embodiment, the distance measurement can be carried out by switching the distance measurement method on the basis of an overall distance between the distance detection device and an object. Accordingly, more appropriate distance measurement can be carried out in accordance with the positional relationship between the distance detection device and the object, the conditions, and so on.

Note that the above-described processing carried out by the calculation processing unit 106 may instead be carried out by the control unit 108 or by the control device 905. Additionally, the object for which the distance is to be detected by the distance detection device according to the present embodiment is not limited to the workpiece 904, and may be any desired object.

The distance detection devices according to the above-described first embodiment and third to seventh embodiments are not limited to configurations applied in a robot device, and may be applied in an image capturing device such as a camera, an endoscope, or the like.

### Other Embodiments

Embodiment(s) of the disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Applications No. 2018-067499, filed on Mar. 30, 2018, and No. 2018-210864, filed on Nov. 8, 2018, which are hereby incorporated by reference herein in their entirety.

What is claimed is:

1. A parallax detection device comprising:
at least one processor; and
a memory coupled to the at least one processor, the memory having instructions that, when executed by the at least one processor, performs operations as:
an obtainment unit configured to obtain an image pair having parallax;
a correlation calculation unit configured to set a base image in one of images in the image pair and calculate a correlation value of the image pair based on the base image; and
a parallax calculation unit configured to calculate a parallax amount of the image pair using the correlation value,
wherein the correlation calculation unit:
sets a first base image in one of the images in the image pair, and calculates a first correlation value based on the first base image; and
sets a second base image in the one of the images in the image pair, at a position different from the position of the first base image with respect to a prescribed direction, and calculates a second correlation value based on the second base image, and
wherein the parallax calculation unit calculates the parallax amount using the first correlation value and the second correlation value.

2. The parallax detection device according to claim 1,
wherein the obtainment unit obtains the image pair having parallax, the image pair being obtained by capturing images of an object onto which patterned light is projected.

3. The parallax detection device according to claim 2,
wherein the patterned light has a line pattern in which a high-brightness region and a low-brightness region extend in a direction perpendicular to the prescribed direction.

4. The parallax detection device according to claim 2,
wherein the correlation calculation unit sets the first base image and the second base image to positions that are different in the prescribed direction by an amount equivalent to one of a width of the first base image in the prescribed direction, and a difference between the stated width and a period of the patterned light in at least one of the images in the image pair.

5. The parallax detection device according to claim 2,
wherein the correlation calculation unit sets the first base image and the second base image to positions that are different in the prescribed direction by an amount equivalent to one of a difference between a width of the first base image in the prescribed direction and a width of a high-brightness region in the patterned light in at least one of the images in the image pair, and an amount obtained by subtracting a period of the patterned light from the stated difference.

6. The parallax detection device according to claim 2,
wherein the correlation calculation unit calculates a period of variation in a pixel value based on the patterned light from the image pair, and determines the position of the second base image based on the calculated period of variation.

7. The parallax detection device according to claim 2, wherein the at least one processor further performs operations as:
a projection unit configured to project the patterned light onto the object.

8. The parallax detection device according to claim 1, wherein the at least one processor further performs operations as:
a determination unit configured to determine whether one of the images in the image pair has periodicity in the prescribed direction,
wherein in the case where one of the images in the image pair has periodicity, the correlation calculation unit calculates the first correlation value and the second correlation value.

9. The parallax detection device according to claim 1,
wherein the correlation calculation unit sets the first base image and the second base image to difference positions in a direction perpendicular to the prescribed direction.

10. The parallax detection device according to claim 1,
wherein the first base image and the second base image are the same size.

11. A parallax detection device comprising:
a projection device that projects patterned light onto an object;
at least one processor; and
a memory coupled to the at least one processor, the memory having instructions that, when executed by the at least one processor, performs operations as:
an obtainment unit configured to obtain an image pair having parallax;
a correlation calculation unit configured to set a base image in one of images in the image pair and calculate a correlation value of the image pair based on the base image; and
a parallax calculation unit configured to calculate a parallax amount of the image pair using the correlation value,
wherein the projection unit projects first patterned light and second patterned light having patterns at positions shifted from each other with respect to a prescribed direction;
the correlation calculation unit:
calculates a first correlation value based on a first image pair obtained by projecting the first patterned light; and
calculates a second correlation value based on a second image pair obtained by projecting the second patterned light; and
wherein the parallax calculation unit calculates the parallax amount using the first correlation value and the second correlation value.

12. The parallax detection device according to claim 11,
wherein the correlation calculation unit calculates the first correlation value and the second correlation value using base images set in the same positions in one of the images in the first image pair and one of the images in the second image pair.

13. The parallax detection device according to claim 11,
wherein the first patterned light and the second patterned light are periodic light in which high-brightness regions and low-brightness regions repeated in an alternating manner in the prescribed direction, and have line patterns in which the high-brightness regions and the low-brightness regions extend in a second direction perpendicular to the prescribed direction.

14. The parallax detection device according to claim 11,
wherein the first patterned light and the second patterned light are patterned light having the same brightness distribution but shifted from each other with respect to the prescribed direction.

15. The parallax detection device according to claim 11,
wherein the projection unit projects the second patterned light so that the pattern of the first patterned light and the pattern of the second patterned light are in different positions with respect to the prescribed direction by an amount equivalent to one of the difference between a width of the base image in the prescribed direction and a width of the high-brightness region in the first patterned light in at least one of the images in the first image pair, and an amount obtained by subtracting the period of the first patterned light in the at least one image from the stated difference.

16. The parallax detection device according to claim 11,
wherein the projection unit projects the second patterned light so that the pattern of the first patterned light and the pattern of the second patterned light are in different positions with respect to the prescribed direction by an amount equivalent to one of the width of the base image in the prescribed direction, and the difference between the stated width and the period of the first patterned light in at least one of the images in the first image pair.

17. The parallax detection device according to claim 13, wherein the at least processor further performs operations as:
an evaluation unit configured to evaluate the period, with respect to the prescribed direction, of the first patterned light in at least one of the images in the first image pair,
wherein the projection unit projects the second patterned light at a position determined on the basis of the evaluated period.

18. The parallax detection device according to claim 11, wherein the at least processor further performs operations as:
a calculation unit configured to calculate a positional shift amount between the first patterned light and the second patterned light in the prescribed direction based on at least one of the images in the first image pair and at least one of the images in the second image pair, and determine a length of the base image in the prescribed direction based on the positional shift amount.

19. The parallax detection device according to claim 11,
wherein the projection unit projects the first patterned light and the second patterned light having different wavelength bands; and
the obtainment unit obtains an image pair based on the first patterned light and an image pair based on the second patterned light separately.

20. The parallax detection device according to claim 1,
wherein the parallax calculation unit calculates the parallax amount using a correlation value calculated by adding, or finding the arithmetic mean of, the first correlation value and the second correlation value.

21. The parallax detection device according to claim 1,
wherein the parallax calculation unit:
calculates a first parallax amount from the first correlation value;
calculates a second parallax amount from the second correlation value; and
calculates a parallax amount of the image pair using a parallax amount obtained by finding the arithmetic mean of the first parallax amount and the second parallax amount.

22. The parallax detection device according to claim 1,
wherein the correlation calculation unit sets a referred image in the other of the images in the image pair, and calculates a correlation value between the base image and the referred image while moving the position of the referred image in the prescribed direction.

23. A parallax detection device comprising:
a projection device that projects patterned light onto an object;
at least one processor; and
a memory coupled to the at least one processor, the memory having instructions that, when executed by the at least one processor, performs operations as:
an obtainment unit configured to obtain an image pair having parallax;
a correlation calculation unit configured to set a base image in one of images in the image pair and calculate a correlation value of the image pair on the basis of the base image; and
a parallax calculation unit configured to calculate a parallax amount of the image pair using the correlation value,
wherein the patterned light includes first sub patterned light and second sub patterned light;
the first sub patterned light and the second sub patterned light are patterned light having positions shifted from each other with respect to a first direction and a second direction perpendicular to the first direction; and
the base image includes an image of a region in which the first sub patterned light and the second sub patterned light are projected.

24. The parallax detection device according to claim 23,
wherein the first sub patterned light and the second sub patterned light are periodic light in which high-brightness regions and low-brightness regions repeat in an alternating manner in the first direction.

25. The parallax detection device according to claim 24,
wherein the first sub patterned light and the second sub patterned light are light in which patterned light having the same brightness distribution are shifted from each other in the first direction and the second direction.

26. The parallax detection device according to claim 24,
wherein the projection unit projects the patterned light so that the first sub patterned light and the second sub patterned light are at different positions in the first direction by an amount equivalent to one of a difference between a width of the base image in the first direction and a width, in the first direction, of the high-brightness region of the first sub patterned light in at least one of the images in the image pair, and an amount obtained by subtracting the period, in the first direction, of the first sub patterned light in the at least one image from the stated difference.

27. The parallax detection device according to claim 24,
wherein the projection unit projects the patterned light so that the first sub patterned light and the second sub patterned light are at different positions in the first direction by an amount equivalent to one of a width of the base image in the first direction, and a difference between the stated width and the period, in the first direction, of the first sub patterned light in at least one of the images in the image pair.

28. The parallax detection device according to claim 23,
wherein the first sub patterned light and the second sub patterned light are light having the same period in the second direction.

29. The parallax detection device according to claim 28,
wherein a length of the base image in the second direction is a length equivalent to an integral multiple of the periods of the first sub patterned light and the second sub patterned light in the second direction.

30. The parallax detection device according to claim 23, wherein the at least processor further performs operations as:
an evaluation unit configured to evaluate the period, in the first direction, of the first sub patterned light in at least one of the images in the image pair, or a difference between the positions, in the first direction, of the first sub patterned light and the second sub patterned light in the at least one image, and determine a length of the base image in the first direction and the second direction based on the period or the positions.

31. The parallax detection device according to claim 23, wherein the at least one processor further performs operations as:
an evaluation unit configured to evaluate the period, in the first direction, of the first sub patterned light in at least one of the images in the image pair, or a difference between the positions, in the first direction, of the first sub patterned light and the second sub patterned light in the at least one image,
wherein the projection unit projects the patterned light having corrected the periods and positions of the first sub patterned light and the second sub patterned light based on the evaluated period or position difference, and the length of the base image in the first direction and the second direction.

32. The parallax detection device according to claim 23,
wherein the correlation calculation unit sets a referred image in the other of the images in the image pair, and calculates a correlation value between the base image and the referred image while moving the position of the referred image in the first direction.

33. A robot device comprising:
a robot arm;
a robot hand provided on the robot arm;
a control device that controls the robot arm and the robot hand; and
a parallax detection device comprising:
at least one processor; and
a memory coupled to the at least one processor, the memory having instructions that, when executed by the at least one processor, performs operations as:
an obtainment unit configured to obtain an image pair having parallax;
a correlation calculation unit configured to set a base image in one of images in the image pair and calculate a correlation value of the image pair based on the base image; and
a parallax calculation unit configured to calculate a parallax amount of the image pair using the correlation value,
wherein the correlation calculation unit:
sets a first base image in one of the images in the image pair, and calculates a first correlation value based on the first base image; and
sets a second base image in the one of the images in the image pair, at a position different from the position of the first base image with respect to a prescribed direction, and calculates a second correlation value based on the second base image, and
wherein the parallax calculation unit calculates the parallax amount using the first correlation value and the second correlation value.

34. The robot device according to claim 33,
wherein the at least one processor of the parallax detection device further performs operations as a distance calculation unit configured to calculate a distance to a workpiece based on the parallax amount;
the parallax detection device obtains distance information including the distance to the workpiece and image information of the workpiece; and
the control device:
estimates the position and attitude of the workpiece using the distance information and the image information; and
controls the robot arm and the robot hand based on the position and attitude.

35. A distance detection device comprising:
at least one processor; and
a memory coupled to the at least one processor, the memory having instructions that, when executed by the at least one processor, performs operations as:
a parallax detection device, the device includes:
an obtainment unit configured to obtain an image pair having parallax;
a correlation calculation unit configured to set a base image in one of images in the image pair and calculate a correlation value of the image pair based on the base image; and
a parallax calculation unit configured to calculate a parallax amount of the image pair using the correlation value,
wherein the correlation calculation unit:
sets a first base image in one of the images in the image pair, and calculates a first correlation value based on the first base image; and
sets a second base image in the one of the images in the image pair, at a position different from the position of the first base image with respect to a prescribed direction, and calculates a second correlation value based on the second base image, and
wherein the parallax calculation unit calculates the parallax amount using the first correlation value and the second correlation value; and
a distance calculation unit configured to detect a distance to an object using a parallax amount detected by the parallax detection device.

36. A parallax detection method comprising:
obtaining an image pair having parallax;
setting a base image in one of images in the image pair and calculating a correlation value of the image pair based on the base image; and
calculating a parallax amount of the image pair using the correlation value,
wherein the calculation of the correlation value includes:
setting a first base image in one of the images in the image pair and calculating a first correlation value based on the first base image; and
setting a second base image in the one of the images in the image pair, at a position different from the position of the first base image with respect to a prescribed direction; and
calculating a second correlation value based on the second base image,
wherein the calculation of the parallax amount includes calculating the parallax amount using the first correlation value and the second correlation value.

37. A parallax detection method comprising:
projecting patterned light onto an object;
obtaining an image pair having parallax;
setting a base image in one of images in the image pair;
calculating a correlation value of the image pair based on the base image; and
calculating a parallax amount of the image pair using the correlation value,
wherein:
the projecting includes projecting first patterned light and second patterned light having patterns at positions shifted from each other with respect to a prescribed direction;
the calculating the correlation value includes:
calculating a first correlation value based on a first image pair obtained by projecting the first patterned light; and
calculating a second correlation value based on a second image pair obtained by projecting the second patterned light,
wherein the calculation of the parallax amount includes calculating the parallax amount using the first correlation value and the second correlation value.

38. A parallax detection method comprising:
projecting patterned light onto an object;
obtaining an image pair having parallax;
setting a base image in one of images in the image pair;
calculating a correlation value of the image pair based on the base image; and
calculating a parallax amount of the image pair using the correlation value,
wherein:
the patterned light includes first sub patterned light and second sub patterned light;
the first sub patterned light and the second sub patterned light are patterned light having positions shifted from each other with respect to a first direction and a second direction perpendicular to the first direction; and
the base image includes an image of a region in which the first sub patterned light and the second sub patterned light are projected.

39. A distance detection method comprising:
obtaining an image pair having parallax;
setting a base image in one of images in the image pair and calculating a correlation value of the image pair based on the base image; and
calculating a parallax amount of the image pair using the correlation value,
wherein the calculation of the correlation value includes:
setting a first base image in one of the images in the image pair and calculating a first correlation value based on the first base image; and
setting a second base image in the one of the images in the image pair, at a position different from the position of the first base image with respect to a prescribed direction; and
calculating a second correlation value based on the second base image,
wherein the calculation of the parallax amount includes calculating the parallax amount using the first correlation value and the second correlation value,
the distance detection method further comprising:
detecting a distance to an object using the parallax amount.

40. A distance detection method comprising:
obtaining a first distance between an object and a distance detection device based on one of a size of the object in an image captured by the distance detection device, and a distance between the object and the distance detection device previously detected for the object;
detecting a second distance between the object and the distance detection device based on a parallax amount calculated through a first parallax detection method in the case where the first distance is greater than a prescribed distance; and
detecting the second distance based on a parallax amount calculated through a second parallax detection method in the case where the first distance is less than or equal to the prescribed distance,
wherein the first parallax detection method comprises:
obtaining an image pair having parallax;
setting a base image in one of images in the image pair and calculating a correlation value of the image pair based on the base image; and
calculating a parallax amount of the image pair using the correlation value,
wherein the calculation of the correlation value includes:
setting a first base image in one of the images in the image pair and calculating a first correlation value based on the first base image; and
setting a second base image in the one of the images in the image pair, at a position different from the position of the first base image with respect to a prescribed direction; and
calculating a second correlation value based on the second base image,
wherein the calculation of the parallax amount includes calculating the parallax amount using the first correlation value and the second correlation value, and
wherein the second parallax detection method comprises:
projecting patterned light onto an object;
obtaining an image pair having parallax;
setting a base image in one of images in the image pair;
calculating a correlation value of the image pair based on the base image; and
calculating a parallax amount of the image pair using the correlation value,
wherein:
the projecting includes projecting first patterned light and second patterned light having patterns at positions shifted from each other with respect to a prescribed direction;
the calculating the correlation value includes:
calculating a first correlation value based on a first image pair obtained by projecting the first patterned light; and
calculating a second correlation value based on a second image pair obtained by projecting the second patterned light,
wherein the calculation of the parallax amount includes calculating the parallax amount using the first correlation value and the second correlation value.

41. A non-transitory storage medium storing a program that when executed by a processor causes the processor to perform a method comprising:
obtaining an image pair having parallax;
setting a base image in one of images in the image pair and calculating a correlation value of the image pair based on the base image; and
calculating a parallax amount of the image pair using the correlation value,
wherein the calculation of the correlation value includes:
setting a first base image in one of the images in the image pair and calculating a first correlation value based on the first base image; and
setting a second base image in the one of the images in the image pair, at a position different from the position of the first base image with respect to a prescribed direction; and
calculating a second correlation value based on the second base image,
wherein the calculation of the parallax amount includes calculating the parallax amount using the first correlation value and the second correlation value.
